(19) United States
(12) Patent Application Publication
(10) Pub. No.: US 2023/0288171 A1
(43) Pub. Date: Sep. 14, 2023

(54) OPTICAL SIGHT RETICLE

(71) Applicant: Dimitri MIKROULIS, Henderson, NV (US)

(72) Inventor: Dimitri MIKROULIS, Henderson, NV (US)

(21) Appl. No.: 18/117,872

(22) Filed: Mar. 6, 2023

Related U.S. Application Data
(60) Provisional application No. 63/318,371, filed on Mar. 9, 2022.

(51) Int. Cl. F41G 1/38; G02B 23/00

(52) U.S. Cl. CPC F41G 1/38; G02B 23/00

(57) ABSTRACT

The disclosure is directed to a reticle for an optical sight of a projectile launching device including, but not limited to a firearm. The reticle provides one or more target acquisition features for a target object of a predetermined width and height including horizontal auto range estimation, vertical auto range estimation, bullet drop compensation, wind adjustment information, moving target lead information, target guidance information, and fire correction information. The reticle includes indicia graduated in angular measurement for horizontal ranging and vertical ranging target objects of known dimensions.

### CROSS-REFERENCE TO RELATED APPLICATIONS

This application is entitled to the benefit of the filing date of the prior-filed U.S. provisional application No. 63/318,371, filed on Mar. 9, 2022.

### BACKGROUND OF THE DISCLOSURE

### 1. Field of the Disclosure

This disclosure relates generally in the field of reticles for telescopic and other optical sighting systems.

### 2. Background Art

Firearms and other projectile launching devices are often equipped with an optical sight comprising a reticle to assist in target acquisition. Some known reticles include, markings or indicia in angular measurement, e.g., milliradians or minutes-of-angle, to provide precision shooting of various targets. However, milliradian reticles and minutes-of-angle reticles require calculations that may prolong or delay optimum target acquisition timing. Other known reticles include markings or indicia that provide calculation free information such as horizontal ranging, vertical ranging, bullet drop compensation, wind adjustment marks and moving target leads for a known target object of a predetermined size, but, such markings or indicia lack horizontal angular measurement marks and vertical angular measurement marks for precision shooting of the target object at various distances.

Overcoming the above shortcomings is desired.

### SUMMARY OF THE DISCLOSURE

The disclosure provides a reticle for an optical sight, comprising (1) a first central scale; (2) one or more first side scales; and (3) one or more moving target lead marks; wherein the first central scale includes (a) a first measurement mark operationally configured as a primary horizontal auto ranging mark for a first target object at a base distance; and (b) a second measurement mark comprising one or more secondary horizontal auto ranging marks for the first target object at one or more incremental distances greater than the base distance; wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and wherein the one or more moving target lead marks are operationally configured as 90.0 degree target full value lead marks and wherein one or more of the one or more moving target lead marks are operationally configured as 45.0 degree target half value lead marks.

The disclosure further provides a reticle for an optical sight, comprising (1) a first central scale; (2) a second central scale; (3) one or more first side scales; and (4) one or more moving target lead marks; wherein the first central scale includes (a) a first measurement mark operationally configured as a primary horizontal auto ranging mark for a first target object at a base distance; and (b) a second measurement mark comprising one or more secondary horizontal auto ranging marks for the first target object at one or more incremental distances greater than the base distance; wherein the second central scale includes a vertical crosshair and one or more horizontal crosshairs graduated in angular measurement as graduated marks of incremental value in relation to the first measurement mark; wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and wherein the one or more moving target lead marks are operationally configured to lead the first target object when the first target object is traveling at a plurality of speeds 90.0 degree full value to an aiming line of sight emanating from the one or more moving target lead marks and wherein one or more of the one or more moving target lead marks are operationally configured to lead the first target object when the first target object is traveling at one or more of the plurality of speeds 45.0 degree half value to the aiming line of sight.

The disclosure further provides a reticle for an optical sight, comprising (1) a first central scale; (2) a second central scale located below the first central scale; (3) one or more first angular measurement side scales; and (4) one or more moving target lead marks; wherein the first central scale is operationally configured for horizontal auto ranging of a first target object according to a selected center mass of the first target object at one or more predetermined first distances and operationally configured for aiming at the first target object at the one or more predetermined first distances and aiming at the first target object at one or more predetermined second distances; wherein the second central scale is operationally configured for aiming of the first target object at one or more third distances less than the one or more predetermined first distances and one or more predetermined second distances; wherein the one or more first angular measurement side scales include indicia operationally configured as (a) vertical auto range estimation marks for the first target object according to a selected full height and selected half height of the first target object at the one or more predetermined first distances, (b) horizontal angular measurement marks for one or more second target objects of known dimensions, and (c) vertical angular measurement marks for the one or more second target objects; and wherein the one or more moving target lead marks are operationally configured as 90.0 degree target full value lead marks and wherein one or more of the one or more moving target lead marks are operationally configured as 45.0 degree target half value lead marks.

The disclosure further provides a method of aiming a firearm of a particular package at a target object of a selected size and shape, comprising (1) presenting the firearm comprising an optical sight with a reticle comprising (a) a first central scale; (b) a second central scale; (c) one or more first angular measurement side scales; (d) one or more second angular measurement side scales; and (e) one or more moving target lead marks; wherein the one or more first angular measurement side scales include one or more indicia operationally configured as vertical auto range estimation marks, horizontal angular measurement marks and vertical angular measurement marks and wherein at least one of the one or more moving target lead marks is operationally configured as a 90.0 degree target full value lead mark and as a 45.0 degree target half value lead mark; and (2) locating an aiming point of the reticle on the target object according to parameters including the width of the target object, the full height of the target object, the half height of the target object, the traveling speed of the target object, the direction of travel of the target object, the wind speed, target guidance information, fire correction information, and combinations thereof.

### BRIEF DESCRIPTION OF THE SEVERAL VIEWS OF THE DRAWING

FIG. 1 is a plan view of an embodiment of a reticle of the disclosure.

FIG. 2 is another plan view of the reticle of FIG. 1 set within a demonstrative sight picture.

FIG. 3 is another plan view of the reticle of FIG. 1.

FIG. 4 is a plan view of part of the reticle of FIG. 1.

FIG. 5 is a plan view of part of the reticle of FIG. 1.

FIG. 6 is a plan view of part of the reticle of FIG. 1.

FIG. 7 is a plan view of part of the reticle of FIG. 1.

FIG. 8 is a plan view of part of the reticle of FIG. 1.

FIG. 9 is a plan view of part of the reticle of FIG. 1.

FIG. 10 is a plan view of part of the reticle of FIG. 1.

FIG. 11 is a plan view of part of the reticle of FIG. 1.

FIG. 12 is a plan view of part of the reticle of FIG. 1.

FIG. 13 is a plan view of part of the reticle of FIG. 1.

FIG. 14 is a plan view of part of the reticle of FIG. 1.

FIG. 15 is a plan view of part of the reticle of FIG. 1.

FIG. 16 is a plan view of part of the reticle of FIG. 1.

FIG. 17 is a plan view of part of the reticle of FIG. 1.

FIG. 18 is a plan view of an embodiment of a reticle of the disclosure.

FIG. 19 is a plan view of part of an embodiment of a reticle of the disclosure.

FIG. 20 is a plan view of part of the reticle of FIG. 1.

FIG. 21 is a plan view of part of the reticle of FIG. 1.

FIG. 22 is a plan view of part of the reticle of FIG. 1.

FIG. 23 is a plan view of part of the reticle of FIG. 1.

FIG. 24 is a plan view of part of the reticle of FIG. 1.

FIG. 25 is a plan view of part of the reticle of FIG. 1.

FIG. 26 is a plan view of part of the reticle of FIG. 1.

FIG. 27 is a plan view of part of the reticle of FIG. 1.

FIG. 28 is a plan view of a central aiming marker and an upper part of a first central vertical crosshair of the reticle of FIG. 1.

FIG. 29 is a simplified illustration of the reticle of FIG. 1 aimed at a target object moving at an oblique angle.

FIG. 30 is a plan view of an embodiment of a reticle of the disclosure.

FIG. 31 is a plan view of part of the reticle of FIG. 30.

FIG. 32 is a plan view of part of the reticle of FIG. 30.

FIG. 33 is a plan view of part of the reticle of FIG. 30.

FIG. 34 is a plan view of an embodiment of a reticle of the disclosure.

FIG. 35 is a plan view of part of the reticle of FIG. 34.

FIG. 36 is a perspective view of a non-limiting example of an optical sight comprising a reticle of this disclosure.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “and/or” includes any and all combinations of one or more of the associated listed items.

### DETAILED DESCRIPTION OF THE DISCLOSURE

For the purposes of promoting an understanding of the principles of the disclosure, reference is now made to the embodiments illustrated in the drawings and particular language will be used to describe the same. It is understood that no limitation of the scope of the claimed subject matter is intended by way of the disclosure.

The terms “first,” “second,” “third,” and the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

in regard to the use of a term in this disclosure in the singular and/or plural, persons of ordinary skill in the art can translate such term(s) from the singular to the plural and/or from the plural to the singular in accordance with the context of the disclosure. The inclusion of “(s)” after an element or a step indicates that one or more than one of such element or step is present with the understanding that each thereof is an independent aspect of the disclosure.

Terms and phrases used in this document, and variations thereof, unless otherwise expressly stated, should be construed as open-ended as opposed to limiting. As examples of the foregoing: the term “including” should be read as meaning; “including, without limitation” or the like, the term “example” is used to provide exemplary instances of the item in discussion, not an exhaustive or limiting list thereof, the terms “a” or “an” should be read as meaning “at least one,” “one or more,” or the like. The use of the term “assembly” does not imply that the components or functionality described or claimed as part of an assembly are all necessarily configured in a common package.

As used in this specification and the appended claims, the terms “optical sight reticle,” “reticle” and “reticule” in relation to projectile launching devices each refers to lines and/or other markings or indicia found on an eyepiece of a sighting device such as an optical sight for one or more projectile launching devices. For purposes of this disclosure, the terms “optical sight reticle,” “reticle” and “reticule” may be used interchangeably.

Herein, a “projectile launching device” may include, but is not limited to a firearm and a crossbow. A firearm may include, but is not limited to a rifle, a shotgun, a pistol, a shoulder fired bazooka, a shoulder fired rocket launcher, an air rifle, and a paintball gun. As understood by the skilled artisan, a particular firearm may be provided in different barrel lengths. The terms “optical sight” may be used interchangeably with the terms “firearm optical sight,” “scope,” “scope sight,” “optical platform,” “optical aiming device,” “optical sighting system,” and “telescopic sight.” In regard to use with one or more rifles, an optical sight may also be referred to as a “riflescope.” In regard to use with pistols, an optical sight may also be referred to as a “pistol scope.” Herein, a person using an optical sight reticle and a corresponding projectile launching device may be referred to as a “shooter” or as a user of the optical sight reticle. An optical sight of this disclosure may include a first focal plane optical sight, a second focal plane optical sight, or a dual focal plane optical sight. Non-limiting examples of optical sights are described in United States Patent Application Publication Number 2021/0164758 A1, titled “Riflescope with Optical Aiming Corrector,” published on Jun. 3, 2021, which is herein incorporated by reference in its entirety; U.S. Pat. No. 7,411,750 B2, titled “Optical Sight,” issued on Aug. 12, 2008, which is herein incorporated by reference in its entirety; U.S. Pat. No. 10,180,565 B2 titled “Viewing Optic with an Integrated Display System,” issued on Jan. 15, 2019, which is herein incorporated by reference in its entirety; and U.S. Pat. No. 4,806,007 titled “Optical Gun Sight,” issued on Feb. 21, 1989, which is herein incorporated by reference in its entirety.

Herein, a “target object” or “target” of a projectile launching device may include an entity, e.g., an “animate object,” and/or an inanimate object of one or more sizes and/or one or more shapes and/or one or more silhouettes. One exemplary target object may include a bullseye target as such term is understood by the skilled artisan comprising a center circle surrounded by one or more outer rings. Another exemplary target object may include a target in the form of a human being including, but not limited to a silhouette target having the general size and shape of a person or upper body of a person as understood by persons of ordinary skill in the art of firearm target shooting. Another target object may include what is referred to herein as an “enemy combatant.” The term “enemy combatant” may include one or more inanimate objects, one or more human beings, one or more living persons, one or more live animals, one or more target objects having the general size and shape of a human being, one or more target objects having the general site and shape of one or more animals as understood by persons of ordinary skill in the art of firearm target shooting. Examples of animals may include, but are not limited to one or more predators acid/or one or more game as encountered dining hunting activities, One exemplary inanimate object may include a silhouette of a general size and shape of (1) an adult human being, or (2) a torso of an adult human being, or (3) an upper body of an adult human being including a head and torso as understood by persons of ordinary skill in the art of firearm target shooting. A silhouette of an enemy combatant target object may include a front facing silhouette or a side facing silhouette in relation to a reticle of an optical sight through which silhouette is viewed. Another inanimate object may include one or more artificial intelligence equipped robot targets. Another inanimate object may include an unmanned aerial target. Non-limiting examples of target objects are described in United States Patent Application Publication Number US 2013/0207347 A1, titled “Reactive Target System,” published on Aug. 15, 2013, which is herein incorporated by reference in its entirety; U.S. Pat. No. 8,807,570 B1, titled “Shooting Target,” published on Aug. 19, 2014, which is herein incorporated by reference in its entirety; United States Patent Application Publication Number US 2006/0125185 A1, titled “Firearm Target Assembly,” published on Jun. 15, 2006, which is herein incorporated by reference in its entirety; U.S. Pat. No. 6,491,303 B1, titled “Portable Target,” published on Dec. 10, 2002, which is herein incorporated by reference in its entirety; U.S. Pat. No. 4,691,925, titled “Portable Steel Target For Pistol Shooting,” published on Sep. 8, 1987, which is herein incorporated by reference in its entirety; U.S. Pat. No. 5,593,162, titled “Target Device,” published on Jan. 14, 1997, which is herein incorporated by reference in its entirety; U.S. Pat. No. 6,575,469 B2, titled “Three-Dimensional Game Target,” published on Jun. 10, 2003, which is herein incorporated by reference in its entirety; United States Patent Application Publication Number US 2016/0327369 A1, titled “Target, System and Method for Markmanship Training,” published on Nov. 10, 2016, which is herein incorporated by reference in its entirety; United States Patent Application Publication Number US 2008/0061509 A1, titled “Firearm Target Assemblies, Target Systems, and Methods for Manufacturing Firearm Targets,” published on Mar. 13, 2008, which is herein incorporated by reference in its entirety; and U.S. Pat. No. 8,757,627 B1, titled “Target Systems,” published on Jun. 24, 2014, which is herein incorporated by reference in its entirety.

Herein, the phrases “close-quarters combat,” “close combat” and “close-quarters battle” may be used interchangeably to define confrontations involving firearms between two or more persons within a distance up to or about 100.0 meters (109.4 yards). As commonly used in military settings, the term “designated marksman” refers to a military role of a marksman assigned to engage human enemy combatants and other target objects at known distances and unknown distances including distances out to or about 600.0 meters (656.17 yards), i.e., a “designated marksman role.”

Regarding an optical sight reticle of this disclosure, the “average center mass” (or “center mass”) of a particular target object includes a designated width of the target object, e.g., the outer shoulder tip to outer shoulder tip (or “shoulder tip to shoulder tip”) width of an enemy combatant directly facing or essentially directly facing the optical sight reticle or when turned 180.0 degrees facing directly away or essentially facing directly away from the optical sight reticle. A shoulder tip to shoulder tip orientation of an enemy combatant is herein referred to as a “primary position” of an enemy combatant. In reference to a human being, the center mass suitably includes the torso or trunk of a person.

For purposes of this disclosure, a distance to a target object refers to a distance from an optical sight reticle to a target object. For example, phrases such as “at a distance of 300.0 meters” and “300.0 meters away,” and like phrases in reference to a target object, mean that the target object is located at a distance 300.0 meters apart from the optical sight reticle.

Herein, the phrase “field of view” (“FOV”) refers to the visible or observable area through an optical element, optical medium or lens of an optical sight for a user or operator of the optical sight, e.g., a shooter, at a particular distance between the operator's eye(s) and the optical element, optical medium or lens of the optical sight. As understood by the skilled artisan, often the larger a lens of an optical sight the larger the field of view of the optical sight at a particular distance between the operator's eye(s) and the optical element.

Regarding an optical sight reticle of this disclosure, the term “mark” may be used to define an indicator of a location of a point on an optical sight reticle including, but not limited to an aiming point on an optical sight reticle. Marks of this disclosure may comprise one or more shapes or configurations including, but not limited to dots, straight horizontal lines, straight vertical lines and straight lines at oblique angles, closed circles, open circles, triangles, stars, chevrons, bullseyes, diamonds, “X” shape marks, “T” shape marks, “Y” shape marks, curved lines, crosses, letters, numbers, arc shapes, solid shapes and silhouette shapes including irregular shapes, and combinations thereof. Herein, the term “dot” need not necessarily be provided in a substantially circular form.

Herein, “cm” refers to centimeters and “m” refers to meters, “mph” refers to miles per hour and “mps” refers to meters per second. Herein, “km/h” refers to kilometers per hour and “ft/s” refers to feet per second. The phrase “lime on target” refers to the time required for an operator of a projectile launching device, e.g., a firearm user or shooter, to realize, the aiming point of a given round to a particular target object in real time, i.e., the time required for target acquisition. Herein, rapid or fast time on target may include a time of or about 3.0 seconds or less. The terms “automatic” and “auto” may be used interchangeably. The terms “auto ranging,” “auto range,” and like terms, refer to the ability to range or range estimate one or more target objects at one or more distances with an optical sight reticle of the disclosure without making or using range estimation calculations. The term “auto leading,” and like terms, refers to the ability to lead one or more moving target objects with an optical sight reticle of the disclosure without making or using lead calculations. The term “auto bullet drop compensation,” and like terms, refers to the ability to identify how far a bullet drops over a given distance without making or using bullet drop calculations. Herein, the act of aiming at a target object refers to using an optical sight reticle of this disclosure to aim a projectile launching device at the target object.

Herein, the term “bullet drop” refers to the curved trajectory traversed by a moving projectile or bullet as it falls from its initial trajectory while traveling a distance, i.e., “target range” or “target distance,” from a projectile launching device to a target object. As understood by the skilled artisan, bullet drop is caused by the influence of gravity on a moving projectile or bullet. Therefore, to hit a target object at long range, it is necessary to elevate a barrel of a projectile launching device, e.g., elevate a barrel of a rifle, to adjust the aiming point to compensate for bullet drop. The term “full value wind” refers to wind blowing perpendicular left to right or right to left in relation to an optical sight reticle, e.g., a cross wind. Using a clock system, full value winds travel “9 to 3” and “3 to 9” in relation to an optical sight reticle. As also understood by the skilled artisan, the term “full value” in reference to wind means that the force of the wind has a full effect on the flight of a bullet compared to a “half value wind” or “no value wind.” As further understood by the skilled artisan, generally, the greater the velocity of wind the greater its force.

Herein, the phrase “variable target” refers to a target object that is changeable in height and/or width. Herein, a “full height” of a human target object is a measurement from the top of the head to the bottom of the feet. For purposes of this disclosure, the phrase “correction of fire” of a projectile launching device means adjusting the point of aim to the point of impact, e.g., adjusting an aiming point of a reticle to the point of impact. Herein, the phrase “weapon system” refers to a firearm and its various components used for purposes of targeting and firing one or more rounds.

Herein, “MRAD” is a shortening of the term milliradian and “MRADs” is a shortening of milliradians. A milliradian is an angular measurement wherein a milliradian is a thousandth of a radian. There are 6.283 radians in a circle, which equates to 6283.0 milliradians in a circle. As understood by persons of ordinary skill in the art of firearm shooting, milliradians are used in the adjustment of firearm sights by adjusting the angle of a sight compared to the barrel of a corresponding firearm. A milliradian reticle may also be referred to as a “MRAD reticle.” A milliradian reticle may also be referred to as a “MRAD optical sight reticle.”

Herein, “MOA” refers to minutes-of-angle, which is an angular measurement wherein one minute of angle is equal to 1/60 of a degree. A minutes-of-angle reticle may also be referred to as a “MOA reticle” or a “MOA optical sight reticle.”

The term “subtension” refers to the amount of a target object that is covered by some part of an optical sight reticle. Subtension may be measured in length at a specific distance, e.g., inches at a distance in yards, or as an angular measurement in MRAD or MOA. Regarding an optical sight reticle of the disclosure, the term “subtension mark” may be used interchangeably with “angular measurement subtension mark” and may be provided as one or more indicia of an optical sight reticle of this disclosure, e.g., as a MRAD subtension mark or as a MOA subtension mark.

In firearm shooting and other projectile targeting activities, it is understood that distances in meters may be converted to yards and vice versa. A non-limiting sampling of conversions for various distances in meters and yards are provided in Tables 1 and 2 below.

TABLE 1

| Distance | Distance |
|---|---|
| (in meters) | (in yards) |
| 50.0 | 54.68 |
| 100.0 | 109.36 |
| 150.0 | 164.04 |
| 200.0 | 218.72 |
| 250.0 | 273.40 |
| 300.0 | 328.08 |
| 350.0 | 382.77 |
| 400.0 | 437.45 |
| 450.0 | 492.13 |
| 500.0 | 546.81 |
| 550.0 | 601.49 |
| 600.0 | 656.17 |

TABLE 2

| Distance | Distance |
|---|---|
| (in yards) | (in meters) |
| 50.0 | 45.72 |
| 100.0 | 91.44 |
| 150.0 | 137.16 |
| 200.0 | 182.88 |
| 250.0 | 228.6 |
| 300.0 | 274.32 |
| 350.0 | 320.04 |
| 400.0 | 365.76 |
| 450.0 | 411.48 |
| 500.0 | 457.2 |
| 550.0 | 502.92 |
| 600.0 | 548.64 |

As understood by the skilled artisan, 1.0 MRAD at 100.0 yards equals 9.14 cm (3.6 inches), 1.0 MRAD at 200.0 yards equals 18.29 cm (7.2 inches) and so forth, as described in Table 3 below out to a distance of 600.0 yards. Likewise, 1.0 MRAD at 100.0 meters equals 10.0 cm and so forth, as described in Table 4 below out to a distance of 600.0 meters.

TABLE 3

| Range | One MRAD | One MRAD |
|---|---|---|
| (in yards) | (in cm) | (in inches) |
| 100.0 | 9.14 | 3.6 |
| 200.0 | 18.29 | 7.2 |
| 300.0 | 27.43 | 10.8 |
| 400.0 | 36.58 | 14.4 |
| 500.0 | 45.72 | 18.0 |
| 600.0 | 54.86 | 21.6 |

TABLE 4

| Range | One MRAD | One MRAD |
|---|---|---|
| (in meters) | (in cm) | (in inches) |
| 100.0 | 10.00 | 3.94 |
| 200.0 | 20.00 | 7.87 |
| 300.0 | 30.00 | 11.81 |
| 400.0 | 40.00 | 15.75 |
| 500.0 | 50.00 | 19.69 |
| 600.0 | 60.00 | 23.62 |

As understood by the skilled artisan, the phrase “30 caliber cartridge” may refer to one or more of the .308 Winchester® (“0.308”), the .30-30 Winchester, the 7.62×51 mm NATO, the 0.30/06, and the 0.30 Carbine cartridge or round. As understood by persons of ordinary skill in the art of firearm shooting, the .308 Winchester and the 7.62×51 mm NATO round are not identical and the .308 Winchester round is typically loaded to a higher pressure than the 7.62×51 mm NATO round. However, the .308 Winchester and the 7.62×51 mm NATO rounds are similar enough to each be loaded into firearms chambered for the other round.

Herein, the .300 Winchester Magnum (or “0.300 Win Mag” or “300WM”) refer to the 7.62×67 mm cartridge or round. The terms “5.45” and “5.45 round” refer to the 5.45×39 mm cartridge or round. Herein, the term “7.62 NATO” refers to the 7.62×51 mm cartridge or round. The term “7.62 Soviet” refers to the 7.62×39 mm cartridge or round. The term “6.5 Creedmoor” refers to the 6.5×48 mm cartridge or round. The terms “6.5 Grendel” and “6.5 mm Grendel” refer to the 6.5×39 mm cartridge or round. The 6 mm Advanced Rifle Cartridge or “6 mm ARC” refers to the 6.0×38 mm cartridge or round.

The terms “5.56” and “5.56 round” refer to the 5.56×45 mm NATO (military designation) cartridge or round. Likewise, the terms “0.223” and “0.223 round” refer to the 0.223 Remington® cartridge or round. As understood by the skilled artisan, although not identical the 0.223 round is often referred to as a “5.56 round” and vice versa.

The terms “M855” and “M855 round” refer to a 5.56 round comprising a gilding, metal-jacketed, lead alloy core bullet with a steel penetrator. The term “MK 262” refers to a 5.56 round available from Black Hills Ammunition, Rapid City, S. Dak., U.S.A. The term “M193” refers to a 5.56 center-fire cartridge with a 55-grain, gilded metal-jacketed, lead alloy core bullet. The skilled artisan understands that the 0.223 round is used in a variety of rifles including, but not limited to AR-15 (“AR”) type rifle platforms. Exemplary AR variants include the M16 rifle (“M16”) and the M4 Carbine (“M4”), which is a variant of the M16. The term “M27” refers to the M27 Infantry Automatic Rifle, which is a magazine-fed 5.56 mm firearm based off of the HK416 rifle produced by Heckler & Koch GmbH, Oberndorf, Germany. The Browning®.50 caliber or “50 Browning” refers to the 12.7×99 mm NATO round or cartridge (hereafter, the 12.7×99 mm).

Herein, the term “cartridge” refers to a projectile packaging for a firearm including at least a bullet, a casing, an explosive propellant and primer. The terms “cartridge” and “round” may be used interchangeably. The term “ammunition” refers to one or more cartridges. For purposes of this disclosure, the terms “ammunition” and “ammo” may be used interchangeably. Herein, a combination of a particular cartridge and firearm chambered for the cartridge may be referred to as a “firearm/ammo combination.”

In an embodiment, the disclosure is related to an optical sight reticle for one or more projectile launching devices, the optical sight reticle including indicia operationally configured to vertically auto range and/or horizontally auto range a target object according to a predetermined center mass of the target object and/or a predetermined height of the target object. As discussed herein, in an embodiment a user of the optical sight reticle may aim and fire upon a target object without having to make any calculations regarding projectile or bullet drop compensation data, wind data, moving target leading data at a plurality of traveling speeds of a target object and at a plurality of traveling angles relative an aiming line of sight emanating from the optical sight reticle, ranging data, fire correction data, and combinations thereof. In an embodiment, the optical sight reticle further comprises indicia including graduated marks graduated in angular measurement operationally configured to range one or more target objects horizontally and vertically. The optical sight reticle further comprises indicia including marks graduated in angular measurement operationally configured so that a second person(s) may guide or walk a shooter to a proper aiming position or point of aim for one or more target objects that the shooter otherwise does not see (herein referred to as “target guidance” and/or “walk-in guidance” and/or “walking a shooter to a target object”). In an embodiment, the optical sight reticle further comprises indicia operationally configured for correction of fire or “fire correction” between a second person(s) and a shooter. In an embodiment, a person providing the target guidance information and/or fire correction information to a shooter is in possession of a like optical sight reticle as the shooter. An optical sight reticle of the disclosure may be incorporated into a substantially flat disc or wafer formed from transparent or substantially transparent optical glass or other material suitable for manufacturing optical lenses.

In an embodiment, the disclosure is related to an optical sight reticle for one or more firearms operationally configured to optimize or otherwise improve firearm shooting accuracy by allowing a shooter to take into account factors including, but not limited to the height and width of a variable target object, bullet drop compensation, wind compensation and the traveling speed of a variable target object relative to what are considered by the skilled artisan as the cardinal directions, i.e., north, south, east, west.

In another embodiment, an optical sight reticle for one or more firearms is provided having pre-set parameters operationally configured to correlate one or more of range estimation information, bullet drop compensation information, wind information, moving target travel speed and direction lead information, target guidance information, fire correction information, and combinations thereof. The optical sight reticle includes a first central scale operationally configured for (1) horizontal ranging and aiming of a variable target such as a human enemy combatant oriented in a primary position ranging from a full height upright standing position to a prone position on the ground according to a predetermined center mass of the target object and (2) adjusting for wind. The optical sight reticle is also provided with one or more separate but integrated corresponding side scales comprising marks for vertical auto range estimation of a variable target oriented in one or more positions different than the primary position, namely, one or more secondary or alternate firing positions according to a predetermined or selected full height of the target object or half height of the target object, e.g., where a human enemy combatant is oriented sideways relative the optical sight reticle or at least oriented less than shoulder tip to shoulder tip relative the optical sight reticle. The one or more side scales are operationally configured to correlate vertical range estimation, target guidance information and fire correction information in real time. The one or more side scales are also marked in angular measurement increments for vertical and horizontal ranging of one or more target objects of known dimensions. The pre-set parameters are operationally configured to extend the accurate range of a weapon system such as a firearm by at least 100.0 percent beyond the weapon system's non-optic capacity.

In another embodiment, the disclosure is related to an optical sight reticle for one or more firearms operationally configured to correlate range estimation, bullet drop compensation and travel speed of a target of a predetermined size and/or shape in windy conditions without having to make calculations to obtain information not already available according to the optical sight reticle configuration.

In another embodiment, the disclosure is related to an optical sight reticle for one or more firearms operationally configured for use with one or more particular caliber firearms in relation to one or more particular target objects.

In another embodiment, the disclosure is related to an optical sight reticle for one or more firearms employing bullet drop compensation ranging and aiming points over a plurality of distances, for example, fifty (50) meter increments, wind compensation or wind adjustment marks according to one or more particular wind speeds over a plurality of distances, and moving target lead marks or leads for target objects traveling at one or more predetermined speeds and at one or more predetermined angles relative an aiming line of sight emanating from the optical sight reticle. The optical sight reticle also includes one or more angular measurement marks for horizontal and vertical range estimation for one or more target objects of known dimensions. The optical sight reticle also includes one or more walk-in lines marked in angular measurement increments.

In another embodiment, the disclosure is related to an optical sight reticle for one or more firearms operationally configured to range and aim at a moving variable target object, e.g., a human enemy combatant or other animal, in real time using known parameters including, but not limited to (1) center mass of the target object according to the shoulder tip to shoulder tip width of the target object, (2) the full height of the target object, (3) the half height of the target object, (4) the traveling speed of the target object, (5) the direction of travel of the target object, (6) the wind speed, (7) target guidance information, (8) fire correction information, and combinations thereof.

In another embodiment, the disclosure is related to an optical sight reticle for one or more firearms operationally configured for use according to a predetermined traveling speed and direction of travel of one or more moving target objects of a predetermined full height and/or width at a given distance from the optical sight reticle.

In another embodiment, the disclosure is related to an optical sight reticle for one or more firearms whereby a user of the optical sight reticle may employ one or more target acquisition features of the optical sight reticle as desired including one or more calculation free auto range estimation marks and one or more marks graduated in angular measurement for use in calculating range estimation of one or more target objects.

In another embodiment, the disclosure is related to a method of ranging at least one target object with an optical sight reticle of this disclosure, the optical sight reticle comprising a central scale displaying bullet trajectory over known distances from the optical sight reticle including target object shoulder tip to shoulder tip width indicators at known distances. The optical sight reticle includes secondary scales to promote optimum target acquisition when the shoulder tip to shoulder tip width of a target object is unattainable or otherwise obstructed from view of the user of the optical sight reticle.

In another embodiment, the disclosure is related to an optical sight reticle employing bullet drop compensation aiming points over a plurality of distances, wind compensation according to one or more wind speeds realized over a plurality of distances and moving target lead marks for target objects traveling at one or more predetermined speeds in real time. As to aiming capabilities in regard to a human enemy combatant, the optical sight reticle is operationally configured to provide shoulder tip to shoulder tip horizontal auto ranging of the enemy combatant at a base distance and correlate bullet drop compensation according to shoulder tip to shoulder tip horizontal range estimation of the enemy combatant at one or more incremental distances from the optical sight reticle greater than the base distance. Shoulder tip to shoulder tip horizontal ranging of an enemy combatant may be accomplished with the enemy combatant oriented in a standing position, seated position, kneeling position and prone position. An optical sight reticle of this disclosure is also operationally configured to vertically range an enemy combatant in standing position, seated position and kneeling position. An optical sight reticle of this disclosure is also operationally configured to vertically range an enemy combatant that is partially obstructed from view, e.g., an enemy combatant standing behind a shrub, bush, rock, fence or other object that rises up to about the waist area of the enemy combatant.

In another embodiment, the disclosure is related to a method for extending the range of a particular weapon system by providing an optical sight reticle comprising marks graduated in angular measurement and marks comprising pre-calculated parameters regarding wind speed, the traveling speed and direction of travel of a variable target object, bullet drop compensation, horizontal ranging information, vertical ranging information, target guidance information, fire correction, and combinations thereof, wherein one or more marks graduated in angular measurement comprise one or more of the pre-calculated parameters.

In another embodiment, the disclosure is related to an optical sight reticle including indicia operationally configured to correlate one or more of bullet drop compensation, horizontal range estimation, vertical range estimation, wind adjustment information, target object travel speed and direction of travel lead information, target guidance information, correction of fire, close quarter combat targeting, and combinations thereof for one or more target objects in a calculation free manner. The optical sight reticle is operationally configured to range a target object at a base distance and one or more incremental distances beyond the base distance. The optical sight reticle includes a plurality of measurement marks including at least one measurement mark operationally configured to provide multiple calculation free auto ranging information. The optical sight reticle also includes a plurality of measurement marks graduated in angular measurement for range estimation of one or more target objects of a known or estimated size, e.g., height and/or width. Because wind may offset a desired path of a projectile such as a bullet, the optical sight reticle may also include one or more wind adjustment marks to allow for aiming adjustments in windy conditions.

In another embodiment, the disclosure is related to an optical sight reticle, system and method for target acquisition of a variable target object, the optical sight reticle having one or more pre-set parameters selected from the group consisting of horizontal range estimation, vertical range estimation, bullet drop compensation, wind adjustment information, target travel speed and direction of travel lead information, target guidance information, fire correction information, and combinations thereof according to a particular firearm package. The optical sight reticle also has one or more marks graduated in angular measurement for ranging one or more target objects.

In another embodiment, the disclosure is related to an optical sight reticle and method of using the optical sight reticle having advantages not taught by the prior art. For example, the disclosure is related to a method of decreasing time on target for a shooter using a firearm of a particular package in relation to one or more first target objects of a selected size and/or shape via an optical sight reticle having a central scale and one or more side scales with pre-set parameters selected from the group consisting of horizontal range estimation, vertical range estimation, bullet drop compensation, wind adjustment information, target travel speed lead information, fire correction information, guidance information, and combinations thereof according to the particular firearm package. The one or more side scales include one or more marks graduated in angular measurement operationally configured for vertical auto ranging one or more target objects, target guidance and fire correction. The one or more side scales also include one or more marks graduated in angular measurement operationally configured for horizontal and vertical range estimation of one or more target objects including one or more second target objects of a size and/or shape different than the selected size and/or shape.

In another embodiment, the disclosure is related to an optical sight reticle operationally configured to include 50.0 meter incremental bullet drop compensation marks or crosshairs providing aiming points out to 800.0 meters. In another embodiment, the disclosure is related to an optical sight reticle operationally configured to include 50.0 meter incremental bullet drop compensation marks or crosshairs providing aiming points out to 1000.0 meters.

In another embodiment, the disclosure is related to an optical sight reticle that may be configured to include integrated moving target lead marks for speeds up to 64.4 km/h (40.0 mph).

In another embodiment, the disclosure is related to an optical sight reticle that may be configured to include full value wind holds (“wind adjustment marks”) for winds ranging from 1.12 mps (2.5 mph) to 4.5 mps (10.0 mph) at distances from 400.0 meters to 800.0 meters.

In another embodiment, the disclosure is related to an optical sight reticle providing horizontal and vertical target ranging and bullet drop compensation of one or more target objects without the need to make any calculations by providing a combination of vertical lines, horizontal lines, and dots in combination with a primary ranging mark in a form including, but not limited to a chevron, a closed circle, a full circle, an inverted “T” shape, an “X” shape, a solid dot, a rectangle, and triangle.

In another embodiment, the disclosure is related to an optical sight reticle having a feature-rich and intuitive design that is uncluttered in a manner effective to communicate various types of information to a user in an efficient manner to (1) increase first-hit probability of a target object, and (2) reduce the time necessary to reach a firing solution to achieve a hit on a target object compared to prior art optical sight reticles.

In another embodiment, the disclosure is related to an optical sight reticle operationally configured for use as part of one or more commercially available firearm optical sights. One non-limiting example of a commercially available firearm optical sight that may incorporate an optical sight reticle of this disclosure at the time of this disclosure includes the Primary Arms® SLX 5×36 Gen III Prism Scope commercially available from Primary Arms, LLC, Houston, Tex., U.S.A.

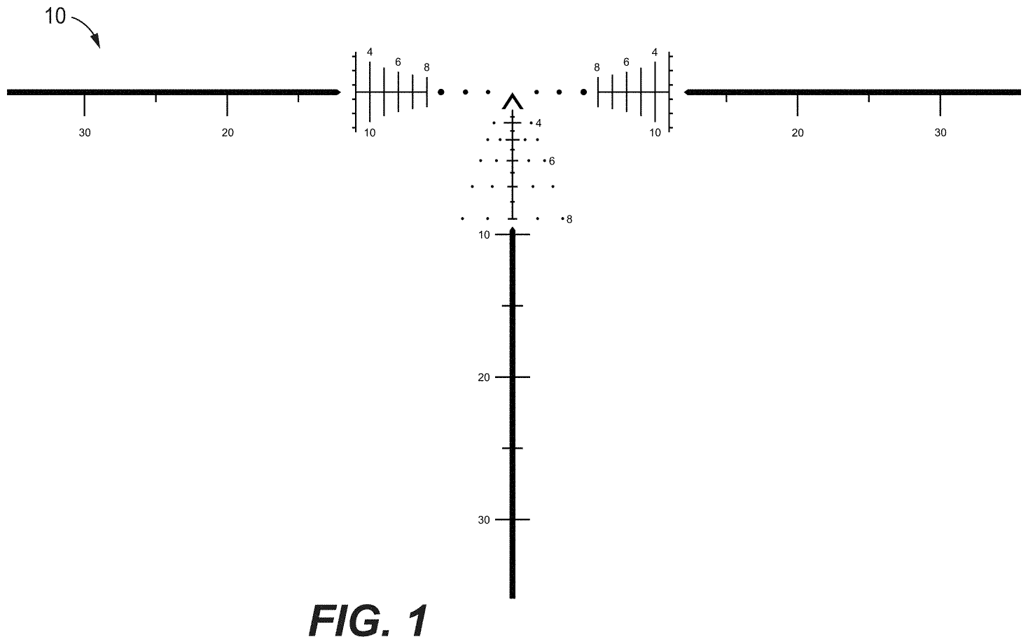

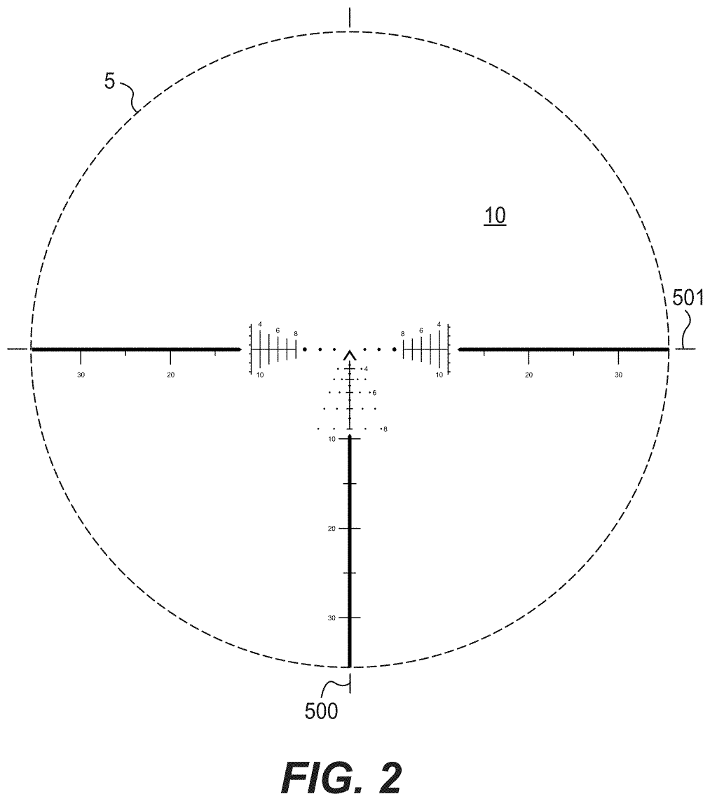

With reference to FIG. 1, an embodiment of an optical sight reticle 10 (hereafter “reticle 10”) of the disclosure is shown. When viewed through an optical sight, the reticle 10 may appear as shown in FIG. 2, which illustrates the reticle 10 set within a demonstrative sight picture 5. As understood by the skilled artisan, a reticle of an optical sight may be placed in either the first focal plane or the second focal plane of the optical sight. When located in a first focal plane of an optical sight, the size of the reticle 10 in relation to its corresponding demonstrative sight picture 5 varies with magnification of the optical sight thereby remaining true to a target object for use of the reticle 10 as described herein. When located in a second focal plane of an optical sight, the reticle 10 is fixed at all magnifications, meaning that the reticle 10 must be set at a particular magnification in order to use the reticle 10 as described herein. Although a selected magnification for a second focal plane reticle 10 may vary, for purposes of this disclosure a reticle 10 located in second focal plane is operable as described herein at full magnification. Although a reticle 10 of this disclosure may be calibrated for a plurality of cartridges and optical platforms, for purposes of discussion, a reticle 10 of this disclosure is described as being calibrated for 5.56 (.223 caliber) rifles from 300.0 meters to 800.0 meters.

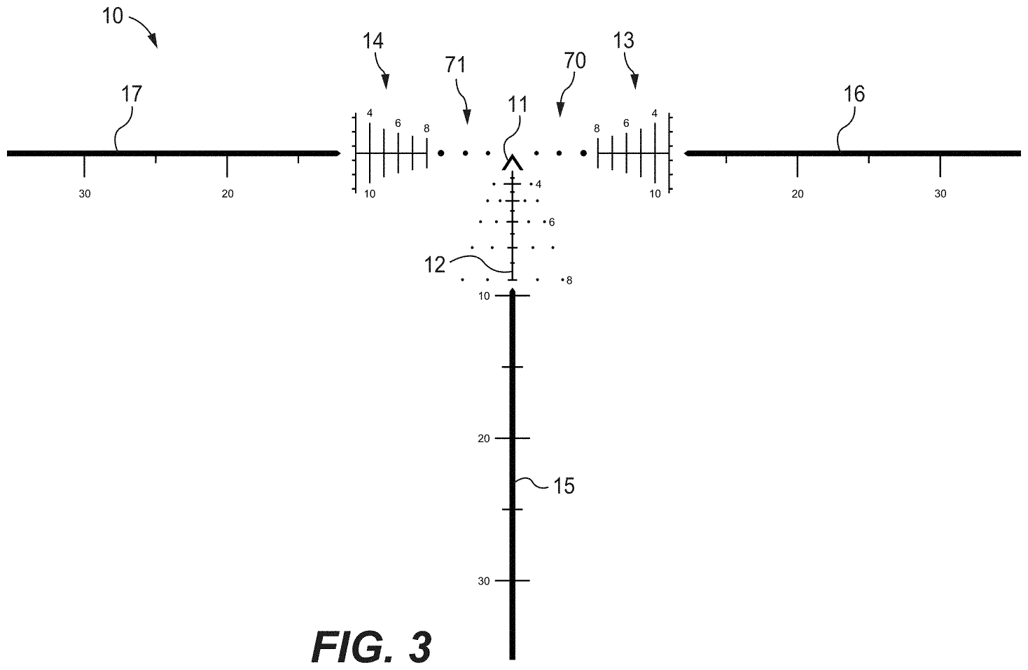

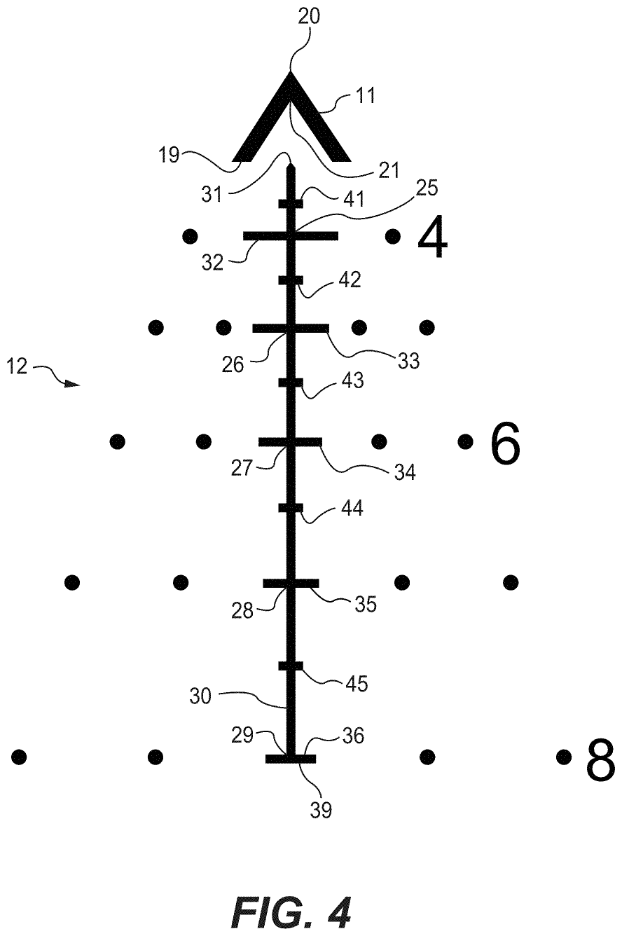

Turning to FIGS. 3 and 4, a reticle 10 of this disclosure comprises one or more indicia or indicators effective as measurement marks and/or aiming marks for one or more target objects. In one embodiment, the reticle 10 may include at least (1) a first measurement mark 11 (also referred to herein as “central aiming mark 11” or “primary aiming mark 11”), (2) a second measurement mark 12 having an uppermost end 31 terminating at a midpoint of a base 19 of the central aiming mark 11 and a distal end 39 terminating at a point below the midpoint of the base 19 of the central aiming mark 11, (3) a third measurement mark 13 in the form of a first side scale positioned right of the central aiming mark 11, (4) a fourth measurement mark 14 in the form of a second side scale positioned left of the central aiming mark 11, (5) a fifth measurement mark 15 located below the second measurement mark 12, (6) a sixth measurement mark 16 located right of the third measurement mark 13, and (7) a seventh measurement mark 17 located left of the fourth measurement mark 14. As described below, the reticle 10 may also include one or more wind adjustment marks and/or one or more moving target lead marks. As FIG. 3 illustrates, the second measurement mark 12, the third measurement mark 13, the fourth measurement mark 14, the fifth measurement mark 15, the sixth measurement mark 16 and the seventh measurement mark 17 are each disposed radially from the central aiming mark 11.

Operation of the reticle 10 is suitably determined according to the set spacing and sizes of the individual indicia or indicators described herein relative to each other. Depending on the characteristics of a particular firearm utilizing the reticle 10, the reticle 10 may be set to range a target object at one or more particular distances as desired. In addition, the reticle 10 employs basic perspective principles known in the field of ranging reticles. For example, a target object appears smaller to an individual the further that the target object is from the individual using the reticle 10.

Although a reticle 10 of this disclosure may be operationally configured as desired, the reticle 10 as shown in FIG. 1 is discussed in terms of a central aiming mark 11 operationally configured for horizontal auto ranging and target acquisition of a target object including a human enemy combatant 99 at a predetermined initial ranging distance (or “base distance”) of the reticle 10 of 300.0 meters (328.08 yards) according to a predetermined average center mass of an enemy combatant 99 of 0.48 meters (19.0 inches), i.e., the “selected center mass” or “selected width” of an enemy combatant 99. As such, the central aiming mark 11 may be referred to herein as a “first horizontal auto ranging mark,” “primary horizontal auto ranging mark,” “first horizontal auto ranging indicator,” or “primary horizontal auto ranging indicator.”

At the base distance of 300.0 meters (328.08 yards), initial vertical auto ranging and target acquisition of a target objecting including a human enemy combatant 99 is accomplished according to a predetermined full height of the enemy combatant 99 of 1.70 meters (67.0 inches), hereafter referred to as the “selected full height” or “selected height,” which describes an individual commonly referred to in the United States of America as being five feet seven inches tall. In another embodiment, a reticle 10 of this disclosure may be operationally configured for initial horizontal ranging and initial vertical ranging of an enemy combatant 99 at a base distance of 274.32 meters (300.0 yards) according to a selected center mass of 0.46 meters (18.0 inches) and a selected full height of 1.78 meters (70.0 inches). As understood by the skilled artisan, the selected center mass and/or selected full height may vary according to one or more intended target objects.

When viewed through an optical sight of a firearm, the free standing central aiming mark 11 is centrally located on an optical medium of an optical sight according to a sight picture 5 as shown in FIG. 2 wherein at least part of the central aiming mark 11 defines a center point of the reticle 10 and wherein the central aiming mark 11 is operationally configured for initial target acquisition correlating to a size requirement of one or more particular target objects at a predetermined or selected base distance from the reticle 10.

Still referring to FIGS. 1-4, in an embodiment the central aiming mark 11 may be provided as a chevron wherein the uppermost part 20 of the chevron, i.e., the uppermost point 20 of the central aiming mark 11, defines a center point of the reticle 10 and is located at an optical center as shown in FIG. 2. In this embodiment, the chevron is set at an upright position with a closed-end oriented as the top of the chevron. In another embodiment, the chevron may be inverted with the closed-end oriented at the bottom of the chevron. In still another embodiment, the central aiming mark 11 may be provided in one or more other forms or shapes other than a chevron. For example, the central aiming mark 11 may have a particular shape operationally configured to equip the reticle 10 for aiming at a particular target object, including animate and inanimate objects of various shapes and sizes. Exemplary alternative shapes of the central aiming mark 11 may include, but are not limited to open chevrons, open circles, cross-hairs (“X” and “+” shapes), open or three-sided rectangles, four-sided rectangles, open spacing of parallel horizontal lines, open spacing of non-parallel horizontal lines, open spacing of parallel vertical lines, open spacing of non-parallel vertical lines, and any other one or more shapes effective for horizontal range estimation and target aiming. In addition, it is further contemplated that each of the above described shapes may be provided in solid lines and/or broken lines and/or dots and/or a plurality of separate other marks collectively forming a desired shape, e.g., a series of lines and/or dots forming a chevron central aiming mark 11.

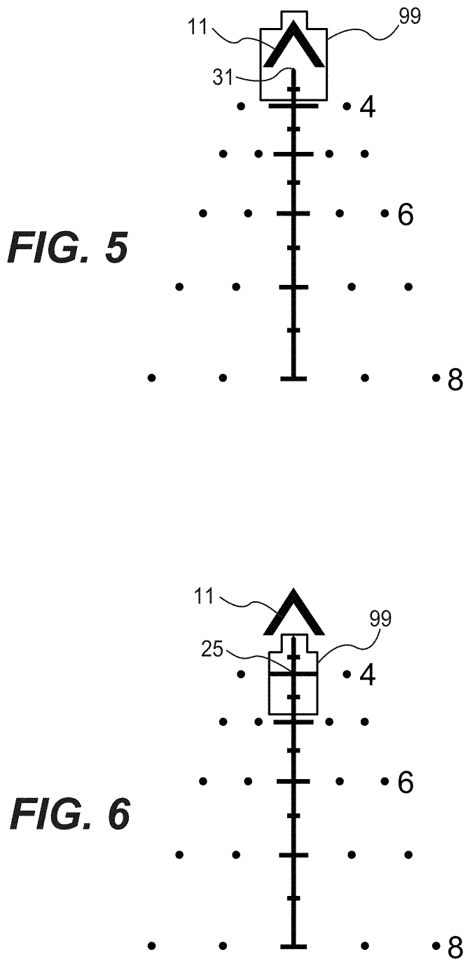

As stated above, in the embodiment of FIGS. 1-4 the central aiming mark 11 of the reticle 10 may be operationally configured for horizontal range estimation of an enemy combatant 99 at a base distance of 300.0 meters based on a center mass of 19.0 inches. Accordingly, in one embodiment the width of the chevron type central aiming mark 11 at its base 19 may be set to or about 1.61 MRAD (5.53 MOA), which corresponds to a center mass of 0.48 meters (19.0 inches) at a distance of 300.0 meters from the reticle 10. At a distance of 300.0 meters, horizontal ranging of an enemy combatant 99 is accomplished using the width of the base 19 of the central aiming mark 11 to auto range estimate an enemy combatant 99 shoulder tip to shoulder tip as shown in FIG. 5. In operation, once an enemy combatant 99 is ranged shoulder tip to shoulder tip at a base distance of 300.0 meters, the uppermost end 31 of a first central vertical crosshair 30, i.e., at the apex of the uppermost end 31, may be used as a target aiming point, exact firing aiming mark, or point of impact on an enemy combatant 99 for shots fired at 300.0 meters (see FIG. 5). For shots fired at 100.0 meters, the uppermost part 20 of the central aiming mark 11, i.e., the uppermost point 20 of the chevron, may be used to provide a target aiming point, exact firing aiming mark, or point of impact on an enemy combatant 99. For shots fired at 200.0 meters, the inner corner 21 of the chevron central aiming mark 11 may be used to provide a target aiming point, exact firing aiming mark, or point of impact on an enemy combatant 99.

As stated above, the reticle 10 is suitably operationally configured to correlate bullet drop compensation with shoulder tip to shoulder tip horizontal range estimation of an enemy combatant 99 at one or more incremental distances greater than the base distance, i.e., greater than 300.0 meters. For firearm distance shooting as often employed by weekend enthusiasts, competition shooters, hunters, law enforcement officers and military snipers, it is important to consider the drop of a bullet over distance. As understood by the skilled artisan, the amount of bullet drop may be determined according to one or more factors including, but not limited to bullet caliber, barrel length, rifling, bullet weight, charge of ammunition, and combinations thereof. Such factors are often referred to by persons of ordinary skill in the art of firearms and shooting as a “package” and are substantially uniform over time for a particular firearm. Thus, as a target object lies further away from a particular reticle 10, the various indicia or indicators of the reticle 10 provided may be oriented and sized for ranging an enemy combatant 99 based on a given package. For example, in an embodiment the second measurement mark 12 of reticle 10 may include at least a first central vertical crosshair 30 that extends downward from a midpoint (left to right) of the central aiming mark 11 vertically along a vertical center line 500 of the reticle 10 (see FIG. 2) and a first horizontal line or first horizontal crosshair 32 intersecting the first central vertical crosshair 30 at a first intersection point 25 for horizontal auto ranging and aiming of an enemy combatant 99 at a first predetermined incremental distance from the reticle 10 greater than the base distance (see FIG. 4). In this embodiment, the width of the first horizontal crosshair 32 correlates to the center mass of an enemy combatant 99 at a first predetermined incremental distance from the reticle 10 greater than the base distance whereby the first horizontal crosshair 32 may be referred to herein as a “second horizontal auto ranging mark,” “secondary horizontal auto ranging mark,” “second horizontal auto ranging indicator,” or “secondary horizontal auto ranging indicator.”

In this embodiment of the reticle 10, the first incremental distance corresponding to the first horizontal crosshair 32 is a distance of 400.0 meters. In operation, once an enemy combatant 99 is ranged shoulder tip to shoulder tip at 400.0 meters according to the width of the first horizontal crosshair 32, the first intersection point 25 is operationally configured as a target aiming point, target aiming mark, exact firing aiming mark, or point of impact on the enemy combatant 99 for shots fired at 400.0 meters (see FIG. 6). In a scenario where wind is not a factor to be considered, the range estimation and the targeting of an enemy combatant 99 may be correlated along the length of the first central vertical crosshair 30 without having to move to a different aiming point as described below.

With further reference to FIG. 4, the reticle 10 may also include one or more additional horizontal crosshairs 33, 34, 35, 36 intersecting the first central vertical crosshair 30 at one or more points as shown operationally configured as a scale for horizontal auto ranging of an enemy combatant 99 shoulder tip to shoulder tip at one or more predetermined incremental distances from the reticle 10 greater than 400.0 meters and for aiming of an enemy combatant 99. Herein, the one or more horizontal crosshairs 32, 33, 34, 35, 36 may be referred to collectively as “second horizontal auto ranging marks 32, 33, 34, 35, 36,” “secondary horizontal auto ranging marks 32, 33, 34, 35, 36,” “second/secondary horizontal auto ranging indicators 32, 33, 34, 35, 36.” In addition, each of the one or more horizontal crosshairs 32, 33, 34, 35, 36 may also be referred to as bullet drop compensation marks, bullet drop compensation indicators, horizontal auto ranging bullet drop compensation marks, and horizontal auto ranging bullet drop compensation indicators.

In this embodiment, a second horizontal line or second horizontal crosshair 33 intersects the first central vertical crosshair 30 at a second intersection point 26 defining a second incremental distance beyond the base distance. The second horizontal crosshair 33 may be referred to herein as a “third horizontal auto ranging mark,” “tertiary horizontal auto ranging mark,” “second horizontal auto ranging indicator,” or “tertiary horizontal auto ranging indicator.”

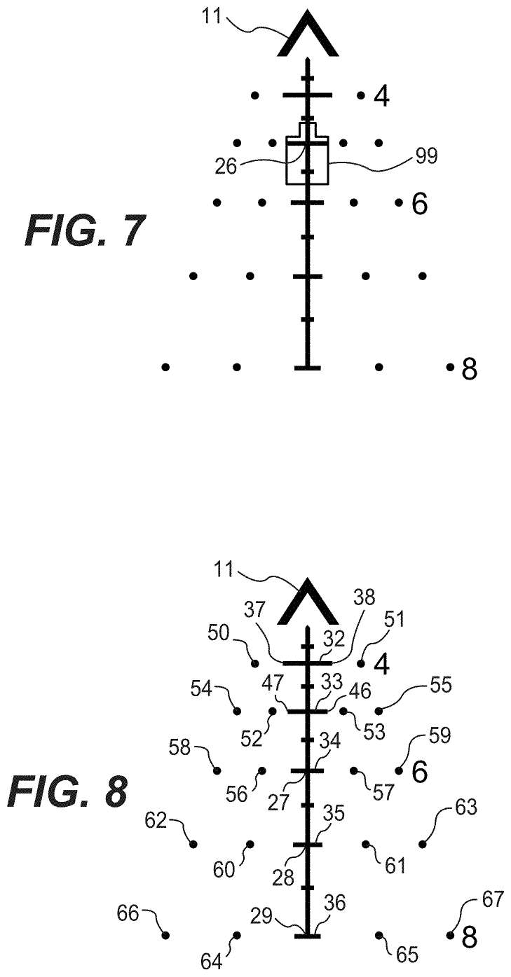

Suitably, the second horizontal crosshair 33 has a width that correlates to the center mass of an enemy combatant 99 at the second incremental distance greater than the base distance whereby the second intersection point 26 provides a target aiming point or point of impact for shots fired at the second incremental distance. In this non-limiting embodiment, the second incremental distance is 500.0 meters. In other words, once an enemy combatant 99 is ranged at a distance of 500.0 meters from the reticle 10, i.e., “ranged at 500.0 meters,” via the second horizontal crosshair 33, the second intersection point 26 may be used to provide a target aiming point, target aiming mark, exact firing aiming mark, or point of impact on an enemy combatant 99 for shots fired at 500.0 meters as shown in FIG. 7.

With further reference to FIG. 4, additional horizontal crosshairs may be provided for horizontal ranging and aiming of an enemy combatant 99 at a distance of 600.0 meters from the reticle 10 using third horizontal crosshair 34 and third intersection point 27, at a distance of 700.0 meters from the reticle 10 using fourth horizontal crosshair 35 and fourth intersection point 28 and at a distance of 800.0 meters from the reticle 10 using fifth horizontal crosshair 36 and fifth intersection point 29 similar as described above regarding first horizontal crosshair 32 and second horizontal crosshair 33. As can be seen in FIG. 4, each succeeding horizontal crosshair in series is narrower left to right, i.e., decreasing in width, corresponding to the shoulder tip to shoulder tip ranging of an enemy combatant 99 at increasing distances apart from the reticle 10.

For purposes of this disclosure, the central aiming mark 11, the first central vertical crosshair 30 and the one or more horizontal crosshairs 32, 33, 34, 35, 36 intersecting the first central vertical crosshair 30 may collectively be referred to as a “central scale” of the reticle 10 and also as a “first central scale” of the reticle 10. In this embodiment of the reticle 10, the first central scale is operationally configured to horizontally auto range an enemy combatant 99 that is directly facing or essentially directly facing the user of a firearm and related reticle 10, or directly facing or essentially directly facing 180.0 degrees in the opposite direction, for shoulder tip to shoulder tip ranging of the enemy combatant 99. Shoulder tip to shoulder tip ranging of an enemy combatant 99 may be accomplished (1) when the enemy combatant 99 is standing upright at a full height of the enemy combatant 99, (2) when the enemy combatant 99 is kneeling on one or two knees, (3) when the enemy combatant 99 is situated in a seated position, (4) when the enemy combatant 99 is in a prone position, and (5) when the enemy combatant 99 is in a supine position.

With further reference to FIG. 4, the intersection point 29 of crosshair 36 is located at the distal end 39 of the first central vertical crosshair 30. In another embodiment, the terminal end of the first central vertical crosshair 30 may be located at a different point on the reticle 10, e.g., the first central vertical crosshair 30 may terminate at a distance for horizontal ranging of an enemy combatant 99 at a distance from the reticle 10 less than or greater than 800.0 meters. As stated above, the reticle 10 may require different bullet drop compensation calibrations for different cartridges and platforms. This is because there are many factors that may determine a projectile or bullet's flight path through space. For example, (1) muzzle velocity, (2) bullet type and (3) altitude may affect how quickly a bullet drops as it travels downrange through space. As such, it is herein contemplated that the reticle 10 may employ bullet drop compensation ranging for distances from the reticle 10 different from the distances described above in relation to FIG. 4. In one simplified example, the reticle 10 may employ bullet drop compensation ranging for distances from 100.0 meters to 500.0 meters. In another simplified example, the reticle 10 may employ bullet drop compensation ranging for distances from 200.0 meters to 800.0 meters. In still another embodiment, the reticle 10 may obtain ranges in yards rather than meters. For example, a reticle 10 as shown in FIG. 1 may be operationally configured to range from 300.0 yards to 800.0 yards. The range of bullet drop compensation and the unit of measure employed for a particular reticle 10 are not limited and the above distances are provided as non-limiting examples.

As further shown in FIG. 4, the first central scale may also include one or more additional horizontal crosshairs 41, 42, 43, 44, 45 intersecting the first central vertical crosshair 30. Herein, the one or more horizontal crosshairs 32, 33, 34, 35, 36 may be referred to as “primary horizontal crosshairs 32, 33, 34, 35, 36” and horizontal crosshairs 41, 42, 43, 44, 45 may be referred to as “secondary horizontal crosshairs 41, 42, 43, 44, 45.” For purposes of this disclosure, the secondary horizontal crosshairs 41, 42, 43, 44, 45 may be provided for bullet drop compensation purposes as bullet drop compensation marks. In the embodiment of FIG. 4, each of the secondary horizontal crosshairs 41, 42, 43, 44, 45 correlates to a fifty meter (50.0 meter) bullet drop increment in relation to the apex of the uppermost end 31 and adjacent primary horizontal crosshairs 32, 33, 34, 35, 36. In another embodiment of the reticle 10, the bullet drop compensation of the secondary horizontal crosshairs 41, 42, 43, 44, 45 may vary from 50.0 meter increments.

The points of intersection of the primary horizontal crosshairs 32, 33, 34, 35, 36 and secondary horizontal crosshairs 41, 42, 43, 44, 45 along the first central vertical crosshair 30 suitably provide target aiming points, exact firing aiming marks, or points of impact on an enemy combatant 99 for shots fired at various distances according to the points of intersection, unless there is wind, whereby the reticle 10 may further include one or more wind adjustment marks to allow for aiming adjustments in windy conditions. Referring to FIG. 4, the distance between the primary horizontal crosshairs 32, 33, 34, 35, 36 progressively increases below the central aiming mark 11 according to the increased bullet drop realized over increasing distances from the reticle 10, i.e., the distance between horizontal crosshairs 35 and 36 is greater than the distance between horizontal crosshairs 33 and 34. Likewise, the distance between the secondary horizontal crosshairs 41, 42, 43, 44, 45 progressively increases below the central aiming mark 11 according to the increased bullet drop realized over increasing distances from the reticle 10 as shown.

As discussed below, one or more of the primary horizontal crosshairs 32, 33, 34, 35, 36 and secondary horizontal crosshairs 41, 42, 43, 44, 45 may be operationally configured as a wind adjustment mark. Likewise, additional wind adjustment marks may be included on either side of the primary horizontal crosshairs 32, 33, 34, 35, 36 and/or secondary horizontal crosshairs 41, 42, 43, 44, 45 as desired or as otherwise required for maximum use and efficiency of the reticle 10.

Referring to FIG. 8, the reticle 10 may include wind adjustment marks as mirror-image indicia in the form of solid dots set in horizontal alignment with corresponding horizontal crosshairs, e.g., primary horizontal crosshairs 32, 33, 34, 35, 36, and spaced apart to correlate to a predetermined wind speed. Herein, the wind adjustment marks may be referred to as “full value wind holds” as such is understood by the skilled artisan. For example, the first horizontal crosshair 32 of this embodiment of the reticle 10 is provided with a set of wind adjustment marks 50, 51 (shown as “wind adjustment dots 50, 51”) on opposite sides of the first horizontal crosshair 32 at a distance effective to compensate for an average cross wind speed of or about 4.5 mps (10.0 mph). In this embodiment, the first horizontal crosshair 32 itself may also be used for purposes of wind adjustment. In other words, not only does the first horizontal crosshair 32 have a width operationally configured to range the center mass of an enemy combatant 99 shoulder tip to shoulder tip at 400.0 meters as described above, but the left side outer edge 37 and right side outer edge 38 of the first horizontal crosshair 32 are operationally configured to compensate for an average cross wind speed of or about 2.2 mps (5.0 mph). As such, at least a first horizontal crosshair 32 is operationally configured to (1) range distance and (2) adjust for wind in real time without the need for a user of the reticle 10 or another to make any calculations. In an embodiment of the reticle 10 as shown in FIGS. 1-4, the central aiming mark 11 does not include wind adjustment marks. However, in another embodiment of the reticle 10, one or more wind adjustment marks may be located on either side of the central aiming mark 11 as desired, for example, one or more wind adjustment marks compensating for an average cross wind speed of or about 4.5 mps (10.0 mph) and/or of or about 2.2 mps (5.0 mph) and/or one or more other average cross wind speeds.

It is further contemplated that the right and left edges of the remaining horizontal crosshairs 33, 34, 35, 36, may also be used for adjusting for wind. However, in regard to each of the remaining primary horizontal crosshairs 33, 34, 35, 36, wind adjustment is suitably accomplished via the inclusion of two or more sets of wind adjustment dots positioned on opposite sides of the crosshairs 33, 34, 35, 36 at distances effective to provide uniform wind adjustment settings to compensate for an average cross wind velocity or speed of at least 2.2 mps (5.0 mph) and 4.5 mps (10.0 mph). For example, horizontal crosshair 33, which is effective for ranging and aiming at an enemy combatant 99 at a distance of 500.0 meters is provided with a first set of wind adjustment dots 52, 53 on opposite sides of the horizontal crosshair 33 operationally configured to compensate for an average cross wind velocity or speed of 2.2 mps (5.0 mph). The horizontal crosshair 33 also includes a second set of wind adjustment dots 54, 55 on opposite sides of the horizontal crosshair 40 operationally configured to compensate for an average cross wind velocity or speed of 4.5 mps (10.0 mph). In this embodiment, wind adjustment may also be accomplished for an average cross wind velocity or speed of 3.4 mps (7.5 mph) by locating a target object halfway between wind adjustment dots 53 and 55 or 52 and 54 depending on the direction of the wind at a particular moment in time. In this embodiment, wind adjustment may also be accomplished for an average cross wind velocity or speed of 1.11 mps (2.5 mph) by locating a target object halfway between wind adjustment dot 53 and the right side outer edge 46 of horizontal crosshair 33 or wind adjustment dot 52 and the left side outer edge 47 of horizontal crosshair 33 depending on the direction of the wind.

As described below, additional sets of wind adjustment dots may be included to account for greater wind speeds and/or lesser wind speeds as desired. As understood by the skilled artisan, each set of additional wind adjustment dots compensating for increasing wind speeds will be located further from the first central vertical crosshair 30 compared to sets of wind adjustment dots compensating for lesser wind speeds.

As further depicted in FIG. 8, each of the remaining primary horizontal crosshairs 34, 35, 36 may also include two or more sets of wind adjustment dots including an inner set of dots effective to compensate for an average cross wind velocity or speed of about 2.2 mps (5.0 mph) and an outer set of dots effective to compensate for an average cross wind velocity or speed of about 4.5 mps (10.0 mph) similar as describe above—see wind adjustment dots 56, 57, 58, 59 corresponding to horizontal crosshair 34, wind adjustment dots 60, 61, 62, 63 corresponding to horizontal crosshair 35, and wind adjustment dots 64, 65, 66, 67 corresponding to horizontal crosshair 36. As shown, each of the sets of wind adjustment dots described above are located at points increasingly further apart from their corresponding intersections 27, 28, and 29 according to the greater the distance that a user is horizontally ranging an enemy combatant 99 beyond the base distance. As understood by the skilled artisan, the wind adjustment dots 51, 53, 55, 57, 59, 61, 63, 65, 67 that are located to the right of the first central vertical crosshair 30 are used for aiming in the presence of a right to left cross wind. Likewise, the wind adjustment dots 50, 52, 54, 56, 58, 60, 62, 64, 66 that are located to the left of the first central vertical crosshair 30 are used for aiming in the presence of a left to right cross wind. In addition, even though the wind adjustment marks of this embodiment are shown as solid dots, in another embodiment the wind adjustment marks may include one or more different or additional forms including, but not limited to one or more closed circles, partially open circles, half circles, rectangles, chevrons, cross-hairs (“X” and “+” shapes), open ended crosshairs, straight lines, curved lines, and combinations thereof.

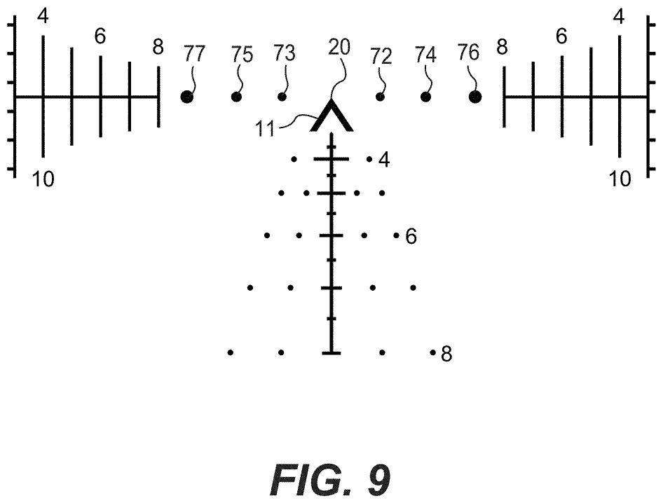

With reference to FIG. 3, in an embodiment the reticle 10 may also include a first set 70 (or “first group 70”) of free standing moving target lead marks (or “leads”) located to the right of the central aiming mark 11 and a second set 71 (or “second group 71”) of free standing moving target lead marks located to the left of the central aiming mark 11 provided as mirror-image indicia on opposite sides of the central aiming mark 11 as shown. In one embodiment, each of the first set 70 and the second set 71 may comprise at least one lead mark. In another embodiment, each of the first set 70 and the second set 71 may comprise a plurality of lead marks operationally configured to lead one or more target objects traveling at a plurality of speeds right to left and/or left to right. As shown in FIG. 9, in an embodiment the first set 70 may comprise three lead marks 72, 74, 76 and the second set 71 may comprise three lead marks 73, 75, 77 mirroring lead marks 72, 74, 76 that are horizontally aligned along a horizontal center line 501 (see FIG. 2) of the reticle 10. In an embodiment, the first set 70 may be referred to as an eighth measurement mark and the second set 71 may be referred to as a ninth measurement mark of the reticle 10.

In this embodiment, the lead marks of the first set 70 and the second set 71 are provided as circular dots with center points set in horizontal alignment with the uppermost part 20 of the central aiming mark 11 on opposite sides of the central aiming mark 11 for efficiency in aiming at a moving enemy combatant 99 traveling at one of three paces, namely, (1) walking (lead marks 72, 73), (2) jogging (lead marks 74, 75), and (3) running (lead marks 76, 77) directionally perpendicular or substantially perpendicular to an aiming line of sight emanating from a lead mark, i.e., a line of sight of a shooter's eye or eye of an individual using the reticle 10 through an optical sight, right to left or left to right while carrying a military type weapon, e.g., AR-15, at a distance apart from the reticle 10 from or about 100.0 meters to or about 300.0 meters. As such, the one or more lead marks 72, 74, 76 and 73, 75, 77 are operationally configured as 90.0 degree full value lead marks relative the aiming line of sight and relative a corresponding bullet's flight path.

In one embodiment, the lead marks of the first set 70 and the second set 71 may be uniform in size and shape. In another embodiment, the lead marks of each set 70, 71 may vary in size and/or shape to assist a user of the reticle 10 in more easily distinguishing between adjacent lead marks. As shown in FIG. 9, in one embodiment the lead marks 72, 74, 76 of the first set 70 and the lead marks 73, 75, 77 of the second set 71 may increase in diameter from the inner most lead marks 72 and 73 to the outer most lead marks 76 and 77 or vice versa.

In one embodiment, the location of lead marks 72 and 73 in relation to the uppermost part 20 of the central aiming mark 11 may correlate to an enemy combatant 99 walking at 4.99 km/h (3.1 mph). The location of lead marks 74 and 75 in relation to the uppermost part 20 of the central aiming mark 11 may correlate to an enemy combatant 99 jogging at 9.82 km/h (6.1 mph). The location of lead marks 76 and 77 in relation to the uppermost part 20 of the central aiming mark 11 may correlate to an enemy combatant 99 running at 13.8 km/h (8.6 mph). As understood by the skilled artisan, in military and law enforcement type settings the term “jogging” may be used interchangeably with “combat jogging” of an enemy combatant 99 and the term “running” may refer to an enemy combatant 99 running at a full sprint while carrying a weapon such as a firearm or other hand held weapon.

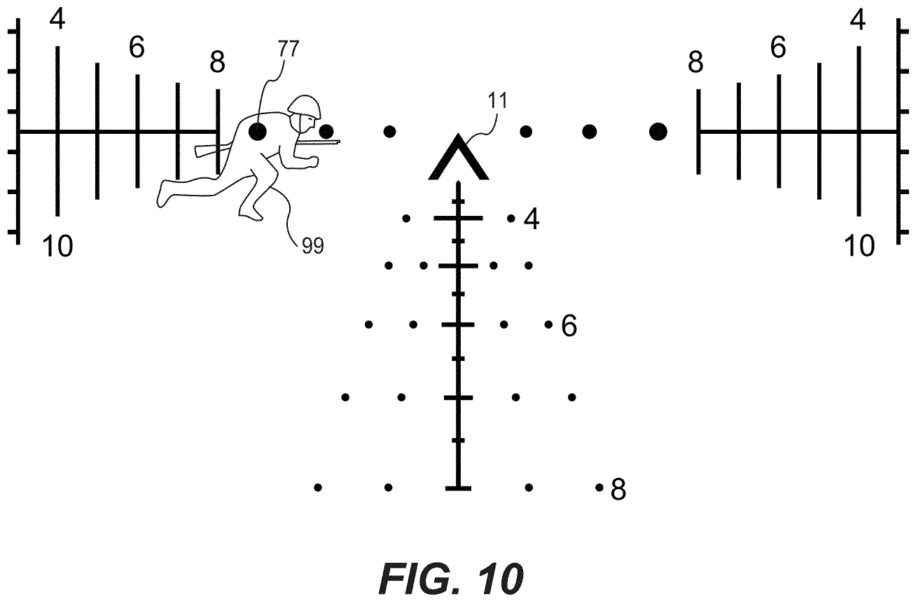

In another embodiment, and for purposes of retention and simplifying use of the reticle 10 for users including, but not limited to, military and law enforcement personnel, the lead marks 72, 74, 76 and 73, 75, 77 may be located apart from the central aiming mark 11 at distances corresponding to walking, jogging and running travel speeds of an enemy combatant 99 that are rounded to the nearest whole number for the travel speeds described above. For example, the location of lead marks 72 and 73 in relation to the uppermost part 20 of the central aiming mark 11 may correlate to an enemy combatant 99 walking at 4.83 km/h (3.0 mph). The location of lead marks 74 and 75 in relation to the uppermost part 20 of the central aiming mark 11 may correlate to an enemy combatant 99 jogging at 9.66 km/h (6.0 mph). The location of lead marks 76 and 77 in relation to the uppermost part 20 of the central aiming mark 11 may correlate to an enemy combatant 99 running at 14.5 km/h (9.0 mph). As an example, where a target object such as an enemy combatant 99 is running left to right at a speed of or about 9.0 mph at a distance apart from the reticle 10 of or about 100.0 to or about 300.0 meters, the left side lead mark 77 may be used as an aiming point for an accurate shot on the enemy combatant 99 rather than the central aiming mark 11 (see FIG. 10).

In addition to operating as right angle or 90.0 degree target full value lead marks, one or more lead marks are also operationally configured as lead marks for an enemy combatant 99 or other target object traveling directionally at one or more oblique angles relative the aiming line of sight. In one embodiment, lead marks 72, 74 and lead marks 73, 75 are operationally configured as 45.0 degree target half value lead marks for an enemy combatant 99 or other target object traveling directionally at or about 45.0 degrees relative the aiming line of sight. In particular, the location of lead marks 74 and 75 in relation to the uppermost part 20 of the central aiming mark 11 may correlate to an enemy combatant 99 running at 13.8 km/h (8.6 mph) directionally at or about 45.0 degrees relative the aiming line of sight 333 (see α3 in FIG. 29). In addition, the location of lead marks 72 and 73 in relation to the uppermost part 20 of the central aiming mark 11 may correlate to an enemy combatant 99 jogging at 9.82 km/h (6.1 mph) directionally at or about 45.0 degrees relative the aiming line of sight 333.

In an embodiment, one or more of the lead marks 72, 74, 76 and lead marks 73, 75, 77 may be set apart from the uppermost part 20 of the central aiming mark 11 at distances that correlate to one or more different estimated travel speeds of an enemy combatant 99. As an example, lead marks 72, 74, 76 and lead marks 73, 75, 77 may be adjusted for terrains such as sand and snow where walking, jogging and running speeds of an enemy combatant 99 are anticipated to be slower, e.g., walking at a speed of or about 3.21 km/h (2.0 mph), jogging at a speed of or about 8.04 km/h (5.0 mph), running at a speed of or about 12.9 km/h (8.0 mph), compared to traveling on a more solid travel surface such as hard ground and paved surfaces. It is also contemplated that in an embodiment a reticle 10 of this disclosure may comprise a first set 70 of lead marks and a second set 71 of lead marks with one or more lead marks that correlate to one or more target speeds different than those described above in reference to an enemy combatant 99.

As understood by the skilled artisan, faster moving targets require a lead of a greater distance than slower moving targets and vice versa. For example, in an embodiment including a live animal target object the location of one or more lead marks may vary compared to a human enemy combatant 99 depending on the type of animal to be targeted. In one non-limiting example, in an embodiment including a target object in the form of an ungulate such as a deer or an antelope, the location of lead marks 72 and 73 in relation to the uppermost part 20 of the central aiming mark 11 may correlate to the animal target walking at or about 4.83 km/h (3.0 mph)—a speed the same or similar to a human enemy combatant 99 in this example. However, the animal target may comprise a higher jogging travel speed and/or a higher running travel speed than a human enemy combatant 99, e.g., the location of lead marks 74 and 75 in relation to the uppermost part 20 of the central aiming mark 11 may correlate to the animal target trotting at or about 16.1 km/h (10.0 mph) and the location of lead marks 76 and 77 in relation to the uppermost part 20 of the central aiming mark 11 may correlate to an animal target running or galloping at or about 56.3 km/h (35.0 mph). Although the one or more lead marks 72, 74, 76 and 73, 75, 77 are shown as solid dots, in another embodiment one or more lead marks of the first set 70 and a second set 71 may be provided in one or more different or additional forms including, but not limited to closed circles, open circles, chevrons, crosshairs, open ended crosshairs, horizontal lines, a plurality of parallel lines, and combinations thereof.

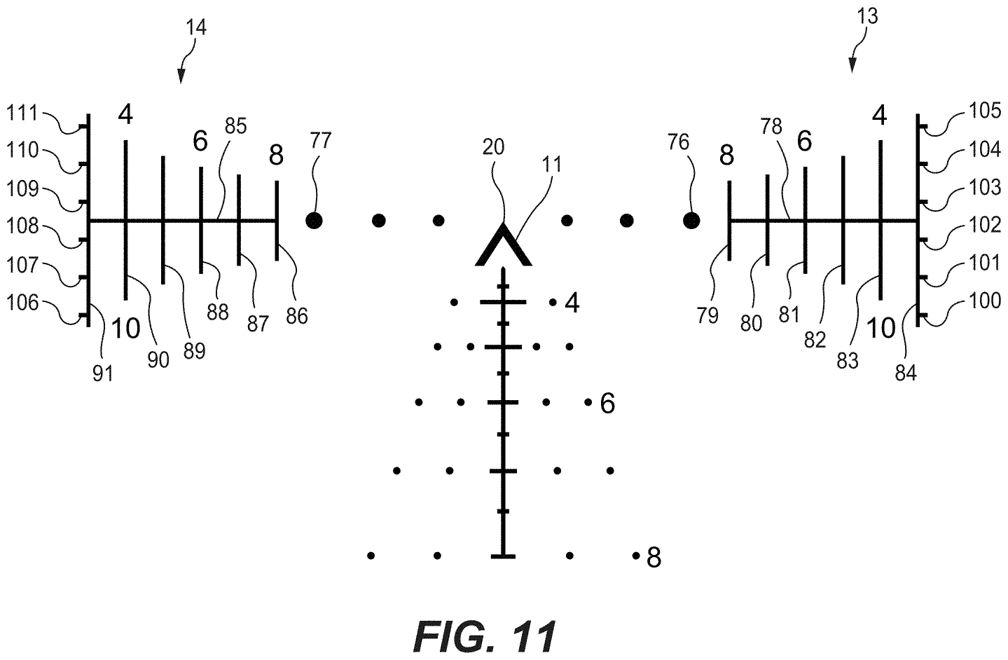

Referring to FIG. 11, in one embodiment of the reticle 10 the third measurement mark 13 and the fourth measurement mark 14 may be provided as mirror-image side scale indicia for real time vertical auto ranging of an enemy combatant 99 according to a selected full height and selected half height of an enemy combatant 99. In other words, each of the third measurement mark 13 and the fourth measurement mark 14 may be utilized for purposes of vertical range estimation when an enemy combatant 99 is not oriented in a primary position and/or in instances where either the lower limbs or torso of an enemy combatant 99 are not within view or clear sight of a user of the reticle 10. Suitably, the third measurement mark 13 and the fourth measurement mark 14 each comprise at least one horizontal mark or crosshair and one or more vertical marks or crosshairs (or one or more “selected height indicators”) intersecting the horizontal crosshair in a manner effective to determine the distance of an enemy combatant 99 from the reticle 10 according to (1) a selected full height of an enemy combatant 99 and/or (2) a selected half height (or “half size”) of an enemy combatant 99 in a scenario where the lower limbs or torso of an enemy combatant 99 are not within view or clear sight of a user of the reticle 10 as described below.

In this embodiment, the third measurement mark 13 comprises a first horizontal mark or line (or “horizontal crosshair 78”) aligned lengthwise with the uppermost part 20 of the central aiming mark 11 and the center point of each of the lead marks 72, 74, 76. As shown, the horizontal crosshair 78 is disposed along the horizontal center line 501 of the reticle 10.

The third measurement mark 13 also comprises vertical marks or lines (“vertical crosshairs 79, 80, 81, 82, 83, 84”) of varying length intersecting the horizontal crosshair 78 at a midpoint of each of the vertical crosshairs 79, 80, 81, 82, 83, 84 at different points along the length of the horizontal crosshair 78 as shown. Said another way, the horizontal crosshair 78 bisects each of the vertical crosshairs 79, 80, 81, 82, 83, 84 into an upper segment disposed above the horizontal crosshair 78 and a lower segment disposed below the horizontal crosshair 78. As stated above, the fourth measurement mark 14 mirrors the third measurement mark 13 and comprises a horizontal mark or line (or “horizontal crosshair 85”) disposed along a center horizontal line of the reticle 10 and vertical crosshairs 86, 87, 88, 89, 90, 91 as depicted in FIG. 11.

In this embodiment, the vertical crosshairs 79, 80, 81, 82, 83, 84 of the third measurement mark 13 and the vertical crosshairs 86, 87, 88, 89, 90, 91 of the fourth measurement mark 14 are operationally configured to assist a user of the reticle 10 in vertically auto ranging one or more enemy combatants 99 according to a full height or a half height of an enemy combatant 99 at one or more predetermined incremental distances corresponding to the (1) the base distance of the central aiming mark 11 and the (2) incremental bullet drop compensation distances of the primary horizontal crosshairs 32, 33, 34, 35, 36 of the first central scale. In other words, the incremental distances of the vertical crosshairs 79, 80, 81, 82, 83, 84 of the third measurement mark 13 and the vertical crosshairs 86, 87, 88, 89, 90, 91 of the fourth measurement mark 14 correspond to the base distance of the central aiming mark 11 and the incremental distances of each of the primary horizontal crosshairs 32, 33, 34, 35, 36.

In this embodiment, the vertical crosshairs 79, 80, 81, 82, 83, 84 of the third measurement mark 13 and the vertical crosshairs 86, 87, 88, 89, 90, 91 of the fourth measurement mark 14 are operationally configured as vertical auto ranging marks to vertically auto range estimate a selected full height of an enemy combatant 99 at distances from 300.0 to 800.0 meters. In particular, the outermost vertical crosshairs 84 and 91 are operationally configured to vertically auto range estimate an enemy combatant 99 at a distance of 300.0 meters from the reticle 10. Vertical crosshairs 83 and 90 are operationally configured to vertically auto range estimate an enemy combatant 99 at a distance of 400.0 meters from the reticle 10. Vertical crosshairs 82 and 89 are operationally configured to vertically auto range estimate an enemy combatant 99 at a distance of 500.0 meters from the reticle 10. Vertical crosshairs 81 and 88 are operationally configured to vertically auto range estimate an enemy combatant 99 at a distance of 600.0 meters from the reticle 10. Vertical crosshairs 80 and 87 are operationally configured to vertically auto range estimate an enemy combatant 99 at a distance of 700.0 meters from the reticle 10 and vertical crosshairs 79 and 86 are operationally configured to vertically auto range estimate an enemy combatant 99 at a distance of 800.0 meters from the reticle 10. As stated above, a target object appears smaller to a viewer the further the target object is from the reticle 10. Accordingly, vertical crosshairs 84 and 91 for vertically auto ranging an enemy combatant 99 at 300.0 meters are greater in length than vertical crosshairs 83 and 90 for vertically auto ranging an enemy combatant 99 at 400.0 meters.

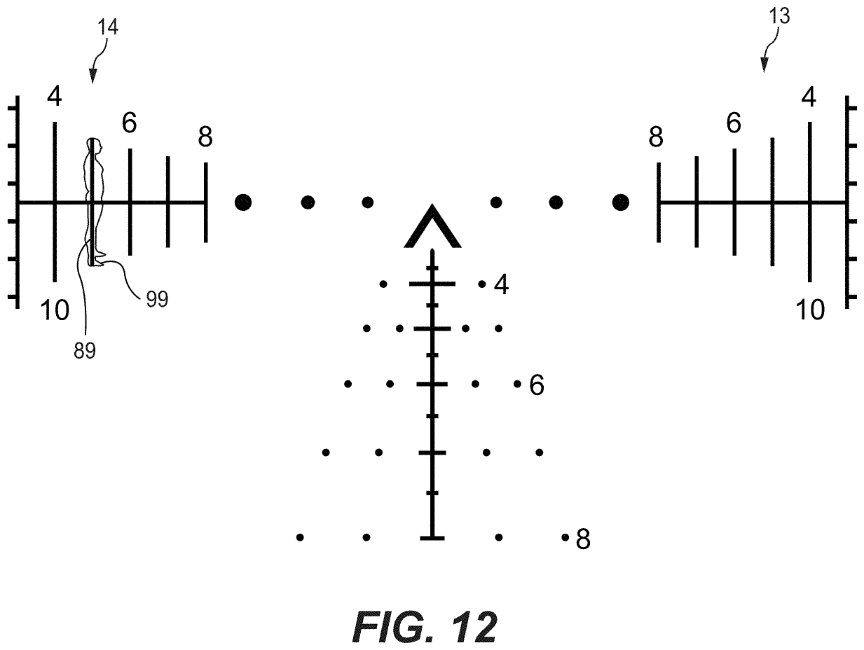

In this embodiment, the full length of each of the vertical crosshairs 79, 80, 81, 82, 83, 84 and 86, 87, 88, 89, 90, 91 top to bottom is operationally configured for ranging the full height of an enemy combatant 99 at each of the predetermined distances of 300.0 meters to 800.0 meters as described above by visually locating an enemy combatant 99 along one of the horizontal crosshairs 78, 85 until the full height of the enemy combatant 99 is equal to or substantially equal to the full length of a particular vertical crosshair. With reference to the simplified example of FIG. 12, a user of the reticle 10 may range an enemy combatant 99 using the fourth measurement mark 14 by visually locating the enemy combatant 99 with the vertical crosshair most similar in height as the enemy combatant 99, which in this example is vertical crosshair 89, effective for range estimating an enemy combatant 99 at a distance of or about 500.0 meters. Such range estimation of an enemy combatant 99 via the third and fourth measurement marks 13 and 14 provides real time distance to target information for an enemy combatant 99 in a calculation free manner.

Again, vertical auto ranging using the vertical crosshairs 79, 80, 81, 82, 83, 84 and 86, 87, 88, 89, 90, 91 is effective in a scenario where an enemy combatant 99 is not oriented in a primary position and/or in instances where either the lower limbs or torso of an enemy combatant 99 are not within view or clear sight. However, for purposes of enhancement of shooting accuracy the third and fourth measurement marks 13 and 14 may be used to vertically auto range an enemy combatant 99 along with horizontal ranging of an enemy combatant 99 via the first central scale.

As understood by the skilled artisan, when using the naked eye for shooting, typically the larger the target object the better the accuracy. As such, as an initial step in aiming at an enemy combatant 99 the full height of the enemy combatant 99 may first be ranged using either the third measurement mark 13 and/or the fourth measurement mark 14 prior to taking aim at the enemy combatant 99 according to a determined intersection point, e.g., 25, 26, 27, 28, 29, along the first central scale.

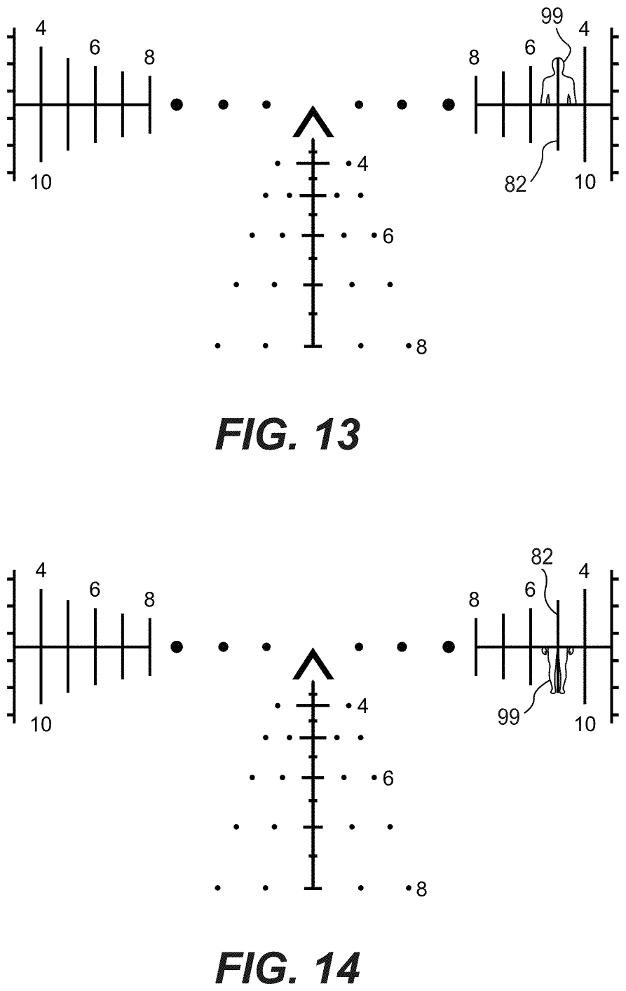

As stated above, the horizontal crosshair 78 bisects each of the vertical crosshairs 79, 80, 81, 82, 83, 84 into an upper segment disposed above the horizontal crosshair 78 and a lower segment disposed below the horizontal crosshair 78 and the horizontal crosshair 85 bisects each of the vertical crosshairs 86, 87, 88, 89, 90, 91 into an upper segment disposed above the horizontal crosshair 85 and a lower segment disposed below the horizontal crosshair 85. For purposes of this disclosure, the length of each individual upper segment and lower segment of each vertical crosshair corresponds to a selected half height of an enemy combatant 99 at a predetermined distance of 300.0 meters to 800.0 meters. Accordingly, in a scenario where the full height of an enemy combatant 99 cannot be ranged either because the lower limbs or torso of an enemy combatant 99 are not within view or clear sight to the user of the reticle 10, e.g., where an enemy combatant 99 drops to one knee or two knees, the height of the enemy combatant 99 may nevertheless be ranged by matching half or about half the height of an enemy combatant 99 with the most corresponding upper segment or lower segment to determine the distance to target of the enemy combatant 99. Herein, for vertical range estimation of a selected half height of an enemy combatant 99, the midpoint of the enemy combatant 99 is identified at or near the bottom of the pelvis of the target individual, i.e., the region of the body where the legs join the torso commonly referred to as the crotch. Thus, the upper half of an enemy combatant 99 on one knee or two knees may be auto ranged from the midpoint to the top of the head as shown in FIG. 13. In a scenario where a torso of an enemy combatant 99 is not within view or clear sight, e.g., obstructed from view of a shooter, the lower half of the enemy combatant 99 may be auto ranged from the midpoint to the bottom of the feet as shown in FIG. 14.

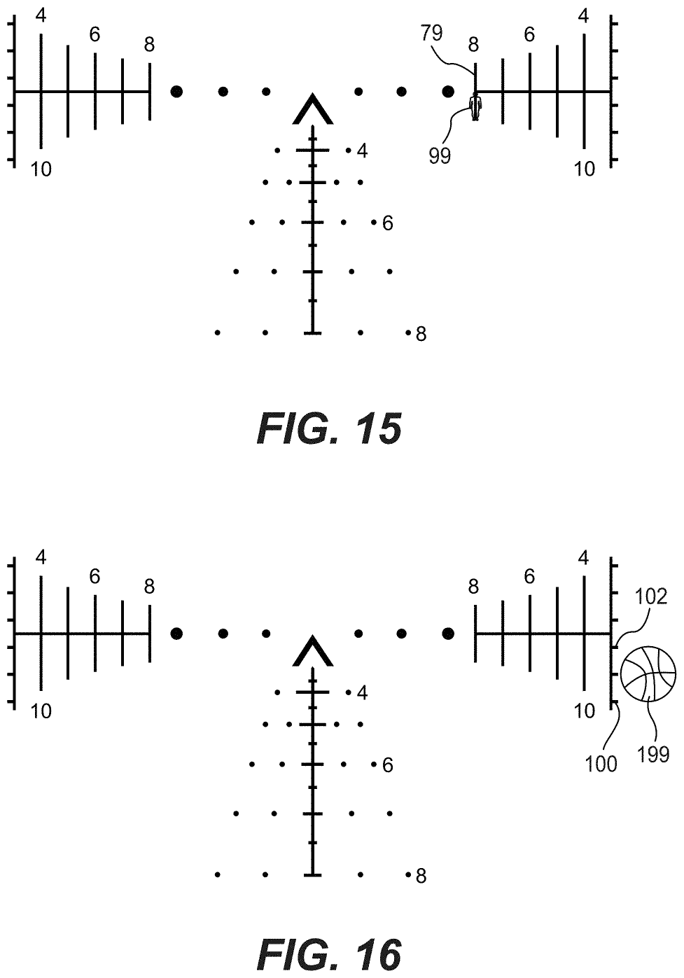

In another scenario, an upper segment or a lower segment of a vertical crosshair may be used to vertically auto range a full height of an enemy combatant 99 that is located a distance greater than 800.0 meters from the reticle 10. Referring to FIG. 15, in one exemplary embodiment where the full height of an enemy combatant 99 corresponds to the lower segment of vertical crosshair 79, with knowledge that the whole vertical crosshair 74 is operationally configured to auto range the full height of an enemy combatant 99 at a distance of 800.0 meters, a user can determine that the enemy combatant 99 is a distance of or about 1600.0 meters from the reticle 10.

In another embodiment, the horizontal crosshairs 78 and 85 may intersect the vertical crosshairs 79, 80, 81, 82, 83, 84 and 86, 87, 88, 89, 90, 91 perpendicularly at a point other than a midpoint to provide upper and lower segments of differing lengths above and below the horizontal crosshairs 78 and 85 for ranging a target object at a selected full height and at one or more other selected heights different than a half height.

With further reference to FIG. 11, one or more of the third measurement mark 13 and one or more of the fourth measurement mark 14 may comprise a plurality of second horizontal marks or horizontal hash marks disposed along the outermost vertical crosshairs 84 and 91 extending out directionally apart from the central aiming mark 11 (see hash marks 100, 101, 102, 103, 104, 105 of the third measurement mark 13 and hash marks 106, 107, 108, 109, 110, 111 of the fourth measurement mark 14). In this embodiment, hash marks 100, 101, 102, 103, 104, 105 and 106, 107, 108, 109, 110, 111 are graduated marks graduated in angular measurement increments. In one embodiment, hash marks 100, 101, 102, 103, 104, 105 and 106, 107, 108, 109, 110, 111 may be set apart in 1.0 MRAD increments and operable as MRAD marks for use in accurate vertical range estimation of one or more target objects of known dimensions using calculations known in the art of MRAD reticles. As understood by the skilled artisan, in range estimation operations many shooters use or otherwise refer to field data books, i.e., DOPE books (Data Obtained from Previous Engagements), comprising potential target object dimensions as well as calculation and shooting adjustment information.

Suitably, the total number of 1.0 MRAD increment hash marks disposed along any one vertical crosshair is determined according to the length of that particular vertical crosshair as configured for vertical auto ranging described above. In this embodiment, each of the outermost vertical crosshairs 84 and 91 comprises a total of six (6) hash marks equal to an angular distance of 5.0 MRAD from each lowermost hash mark to each uppermost hash mark, i.e., 5.0 MRAD from hash mark 100 to hash mark 105 and 5.0 MRAD from hash mark 106 to hash mark 111. As shown, each of the individual hash marks may be uniform in width and thickness and each of the hash marks may extend out from their corresponding vertical crosshair 84 or 91 a distance readily viewable for ease of use. In another embodiment, one or more individual hash marks may comprise a width and/or thickness different from one or more other individual hash marks.

In this embodiment, hash marks 100, 101, 102, 103, 104, 105 and 106, 107, 108, 109, 110, 111 are operationally configured to vertically range estimate a target object according to angular measurement increments of the hash marks using formulas known in the art of MRAD reticles. As an example, where a target object to range estimate includes a basketball 199 having a known diameter of 25.4 cm (10.0 inches) and the hash marks 100, 101, 102, 103, 104, 105 of the third measurement mark 13 are used for vertically ranging the basketball 199, the hash marks may be located over the basketball 199 or located adjacent the basketball 199 as shown in FIG. 16 using a desired hash mark as a baseline mark located at or near the bottom of the basketball 199 and then measuring or counting the number of MRADs to the top of the basketball 199. In the illustration of FIG. 16, the basketball covers a measured 2.0 MRAD from a baseline hash mark 100 to hash mark 102. The estimated range of the basketball 199 may be calculated using what is often referred to in the art of firearm ranging as the “MTh Relation formula” shown in Table 5 including a constant of 25.4.

TABLE 5
Known Size of Target Object (inches) × 25.4/MRAD
Size of Target Object = Distance (meters).

As stated above, the basketball 199 covers a measured 2.0 MRAD. Dividing 254 by 2.0 equals 127.0 meters, which means that the basketball 199 is a distance of or about 127.0 meters from the reticle 10.

In addition to being operationally configured to vertically auto range a selected full height and half height of an enemy combatant 99 at distances from 300.0 meters to 800.0 meters as described above, the vertical crosshairs 79, 80, 81, 82, 83, 84 of the third measurement mark 13 and the vertical crosshairs 86, 87, 88, 89, 90, 91 of the fourth measurement mark 14 are also operationally configured as a scale comprising graduated marks graduated in angular measurement of 1.0 MRAD increments, increments of angular measurement effective for use of the reticle 10 in making accurate horizontal range estimation calculations using one or more formulas as described herein. Referring to the embodiment of FIG. 11, the angular distance from vertical crosshair 79 to vertical crosshair 84 is equal to 5.0 MRAD and the angular distance from vertical crosshair 86 to vertical crosshair 91 is equal to 5.0 MRAD.

As understood by the skilled artisan, MRAD marks spaced apart at an angular distance greater than 1.0 MRAD means that there are fewer MRAD marks across a particular angular distance of a reticle, resulting in decreased accuracy in making range estimation calculations. Herein, MRAD increments of 1.0 MRAD or less may be referred to as “precision increments.” For purposes of this disclosure, the dual use of the vertical crosshairs 79, 80, 81, 82, 83, 84 and 86, 87, 88, 89, 90, 91 for both vertical auto ranging and MRAD horizontal ranging may be referred to as “auto ranging/precision angular measurement integration” and the vertical crosshairs 79, 80, 81, 82, 83, 84 and 86, 87, 88, 89, 90, 91 may be referred to herein as “auto ranging/precision angular measurement integration marks.” In another embodiment of the reticle 10 provided as an MOA reticle, the vertical crosshairs 79, 80, 81, 82, 83, 84 and 86, 87, 88, 89, 90, 91 and hash marks 100, 101, 102, 103, 104, 105 and 106, 107, 108, 109, 110, 111 may be provided in 1.0 MOA increments or less.

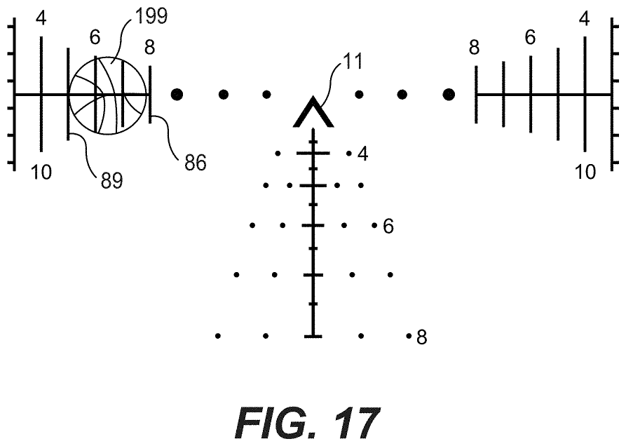

Referring to FIG. 11, each of the vertical crosshairs of the third measurement mark 13 and the fourth measurement mark 14 are set apart in 1.0 MRAD increments and operable as MRAD marks for use in horizontal range estimation of one or more target objects of known dimensions using calculations known in the art of MRAD reticles. As an example, where a target object to range estimate includes a basketball 199 having a known diameter of 25.4 cm (10.0 inches) and the vertical crosshairs 86, 87, 88, 89, 90, 91 of the fourth measurement mark 14 are used for horizontally ranging the basketball 199, the vertical crosshairs may be located over the basketball 199 as depicted in FIG. 17 using a desired vertical crosshair as a baseline mark at or near a right or left side edge of the basketball 199 and then measuring or counting the number of MRADs to the opposite side of the basketball 199. In the illustration of FIG. 17, the basketball 199 covers a measured 3.0 MRAD from a baseline vertical crosshair 86 to vertical crosshair 89. Using the formula of Table 5, in this example the basketball 199 is calculated to be a distance from the reticle 10 of or about 84.67 meters. Although the reticle 10 is depicted covering the basketball 199 in FIG. 17, in another embodiment the basketball 199 may be measured by locating the basketball 199 either above or below vertical crosshairs 86, 87, 88, 89, 90, 91 of the fourth measurement mark 14.

Another feature of the reticle 10 is that the vertical crosshairs 79, 80, 81, 82, 83, 84 of the third measurement mark 13 and the vertical crosshairs 86, 87, 88, 89, 90, 91 of the fourth measurement mark 14 are graduated in angular measurement as graduated marks of incremental value and operationally configured as a scale in relation to the central aiming mark 11, in particular, in relation to a center point of the central aiming mark 11, e.g., the uppermost point 20 of the chevron as shown in FIG. 11. As such, each of vertical crosshairs 79, 80, 81, 82, 83, 84 and vertical crosshairs 86, 87, 88, 89, 90, 91 operates dually as a vertical auto ranging mark and as an angular measurement mark for horizontal range estimation in relation to the central aiming mark 11. Moreover, in the embodiment of FIG. 11 each of vertical crosshairs 84 and 91 is provided as an indicia operationally configured as a vertical auto ranging mark, a horizontal angular measurement mark and a vertical angular measurement mark. Accordingly, a reticle 10 of this disclosure comprises one or more indicia operationally configured as a vertical auto ranging mark, a horizontal angular measurement mark and a vertical angular measurement mark. Herein, the third and fourth measurement marks 13 and 14 may also be referred as “first angular measurement side scales” of the reticle 10 in relation to the central aiming mark 11.

In one embodiment, each of the first set 70 and the second set 71 may comprise at least one lead mark graduated in angular measurement as a graduated mark of incremental value in relation to a center point of the central aiming mark 11, e.g., the uppermost point 20 of the chevron as shown in FIG. 11. Herein, the central aiming mark 11 may be referred to as a point of origin mark whereby the angular measurements of lead marks of the first set 70 and second set 71 and vertical crosshairs 79, 80, 81, 82, 83, 84 and 86, 87, 88, 89, 90, 91 may be used as MRAD marks for use in horizontal range estimation in relation to the central aiming mark 11 for one or more target objects of known dimensions using calculations known in the art of MRAD reticles. As such, one or more lead marks of the first set 70 and second set 71 and the vertical crosshairs 79, 80, 81, 82, 83, 84 and vertical crosshairs 86, 87, 88, 89, 90, 91 may be referred to collectively as “horizontal angular measurement marks.” For example, in the embodiment of FIG. 11 each of the lead marks 76 and 77 is operationally configured as a graduated mark covering 5.0 MRAD from a center point of the central aiming mark 11 to a center point of each of lead mark 76 and lead mark 77; vertical crosshairs 79 and 86 are operationally configured as graduated marks covering 6.0 MRAD from a center point of the central aiming mark 11; vertical crosshairs 80 and 87 are operationally configured as graduated marks covering 7.0 MRAD from a center point of the central aiming mark 11; vertical crosshairs 81 and 88 are operationally configured as graduated marks covering 8.0 MRAD from a center point of the central aiming mark 11; vertical crosshairs 82 and 89 are operationally configured as graduated marks covering 9.0 MRAD from a center point of the central aiming mark 11; vertical crosshairs 83 and 90 are operationally configured as graduated marks covering 10.0 MRAD from a center point of the central aiming mark 11; and vertical crosshairs 84 and 91 are operationally configured as graduated marks covering 11.0 MRAD from a center point of the central aiming mark 11.

In addition, the third measurement mark 13 and the fourth measurement mark 14 may include at least one angular measurement numeral corresponding to a particular vertical crosshair indicating an angular distance from the vertical crosshair to the center point of the central aiming mark 11. In the embodiment of FIG. 11, an angular measurement numeral “10” representing an angular measurement of 10.0 MRAD from a center point of the central aiming mark 11 is located below each of vertical crosshairs 82 and 90 to visually indicate to a user of the reticle 10 the angular distance for the corresponding crosshairs from a center point of the central aiming mark 11. In another embodiment, one or more additional angular measurement numerals may be included as part of the reticle 10 located below one or more other vertical crosshairs identifying the angular measurement from the center point of the central aiming mark 11 to the vertical crosshairs, however, to reduce cluttering of indicia and/or to maximize vision of objects through an optical medium out beyond the indicia of the reticle 10, the reticle 10 may be limited to use of a single angular measurement numeral as shown. In another embodiment, one or more angular measurement numerals other than angular measurement numeral “10” may be located below corresponding vertical crosshair(s), e.g., an angular measurement numeral “7” representing 7.0 MRAD may be located below each of vertical crosshairs 80 and 87. In another embodiment, one or more angular measurement numerals may be located above corresponding vertical crosshairs. In another embodiment, one or more angular measurement numerals may be located both above and below corresponding vertical crosshairs.

Referring to FIGS. 8 and 11, the reticle 10 may also include one or more distance numerals for visually indicating to a user ranging distance information for one or more particular primary horizontal crosshairs of the first central scale. For example, one or more distance numerals may be located to the right and/or the left of one or more corresponding wind adjustment dots of the first central scale. In this embodiment, a distance numeral “4” is located to the right of wind adjustment dot 51, whereby the distance numeral “4” represents a distance of 400.0 meters. Likewise, a distance numeral “6” is located to the right of wind adjustment dot 59 representing a distance of 600.0 meters and a distance numeral “8” is located to the right of wind adjustment dot 67 representing a distance of 800.0 meters. In another embodiment, the reticle 10 may be provided with fewer distance numerals or additional distance numerals as desired, e.g., a distance numeral “5” may be located to the right of wind adjustment dot 55 and/or a distance numeral “7” may be located to the right of wind adjustment dot 63. In another embodiment, the distance numerals may be represented by actual distances. For example, the distance numeral “400” may be located adjacent wind adjustment dot 51 and/or wind adjustment dot 50 as well as located adjacent the first horizontal crosshair 32 in an embodiment devoid of wind adjustment marks. However, single digit distance numerals such as “4,” “6,” and “8” may be desirable for minimizing the surface area of indicia comprising aspects of the reticle 10, e.g., to reduce cluttering of indicia and/or to maximize vision of objects through an optical medium out beyond the indicia of the reticle 10.

Similar as the first central scale, the third and fourth measurement marks 13 and 14 (or “first side scale 13” and second side scale 14″) may also include distance numerals as visual indicators corresponding to the vertical auto ranging distances described above to provide ranging distance information for one or more particular vertical crosshairs 79, 80, 81, 82, 83, 84 and/or vertical crosshairs 86, 87, 88, 89, 90, 91. Herein, the third and fourth measurement marks 13 and 14 may also be referred as “inner side scales” of the reticle 10.

With reference to FIG. 11, a distance numeral “4” may be located above vertical crosshairs 83 and 90, whereby the number “4” represents a distance of 400.0 meters. Likewise, a distance numeral “6” may be located above vertical crosshairs 81 and 88 representing a distance of 600.0 meters and a distance numeral “8” may be located above the vertical crosshairs 79 and 86 representing a distance of 800.0 meters. In another embodiment, one or more different distance numerals may be employed, e.g., a distance numeral “5” located above vertical crosshairs 82 and 89 representing a distance of 500.0 meters. In another embodiment, one or more vertical auto ranging distance numerals may be located below corresponding vertical crosshairs. In still another embodiment, one or more distance numerals may be located both above and below corresponding vertical crosshairs. Although not limited to a particular arrangement, the angular measurement numerals and the distance numerals are suitably located on opposing ends of the vertical crosshairs as shown.

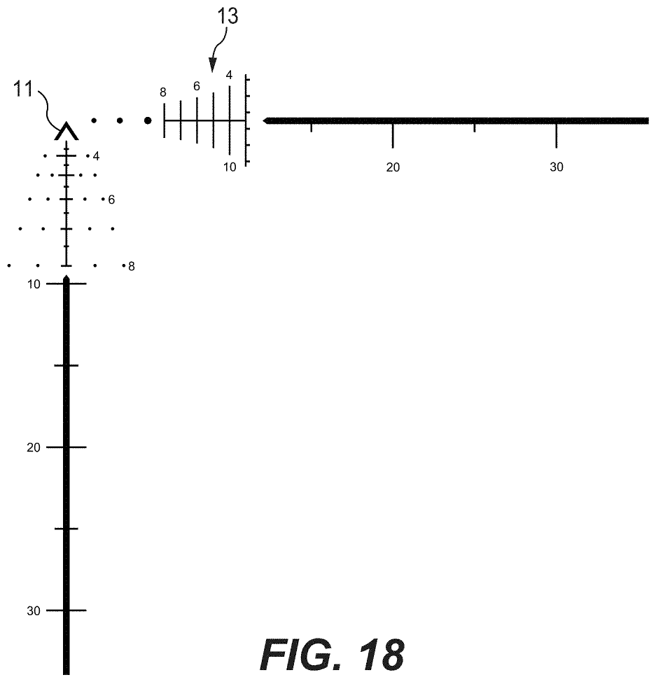

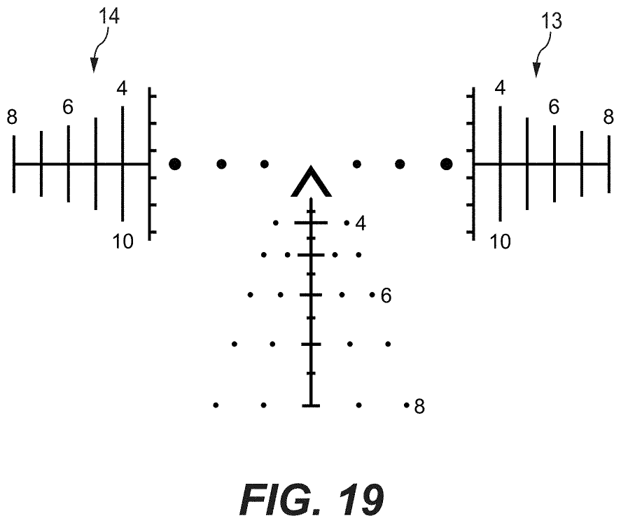

Although the horizontal crosshairs 78 and 85 described above are shown each having a length effective to form intersections for each of the vertical crosshairs 79, 80, 81, 82, 83, 84 and/or vertical crosshairs 86, 87, 88, 89, 90, 91, in another embodiment the horizontal crosshairs 78 and 85 may comprise lengths greater than or less than the lengths as shown in FIG. 11. It is also contemplated that additional vertical crosshairs indicative of other distances from the reticle 10 may be included for intersecting the horizontal crosshairs 78 and 85 as vertical auto range estimation marks and as horizontal angular measurement marks as desired. In still another embodiment, a reticle 10 of this disclosure may be provided with a single side scale, i.e., with only one of either the third measurement mark 13 or the fourth measurement mark as shown in FIG. 18. In still another embodiment, the third and fourth measurement marks 13 and 14 may be provided with vertical crosshairs in reverse order as shown in FIG. 19. In another embodiment, the horizontal crosshairs 78 and 85 and/or the vertical crosshairs 79, 80, 81, 82, 83, 84 and/or vertical crosshairs 86, 87, 88, 89, 90, 91 may be provided as broken lines or a combination of broken lines and/or solid lines and/or dots.

With reference again to FIG. 3, the fifth measurement mark 15, the sixth measurement mark 16 and the seventh measurement mark 17 comprise linear marks disposed radially from central aiming mark 11. Herein, the fifth measurement mark 15 is a vertical mark that may also be referred to as a “bottom post” and also as a “second central scale.” The sixth measurement mark 16 is a horizontal mark that may also be referred to as a “right post” and the seventh measurement mark 17 is a horizontal mark that may be referred to herein as a “left post” of the reticle 10. In this embodiment, the fifth measurement mark 15 is linearly aligned vertically with the first central vertical crosshair 30 of the second measurement mark 12 as shown. The sixth measurement mark 16 is linearly aligned horizontally with the horizontal crosshair 78 of the third measurement mark 13. The seventh measurement mark 17 is linearly aligned horizontally with the horizontal crosshair 85 of the fourth measurement mark 14. The sixth measurement mark 16 and the seventh measurement mark 17 may be referred as “outer side scales” of the reticle 10.

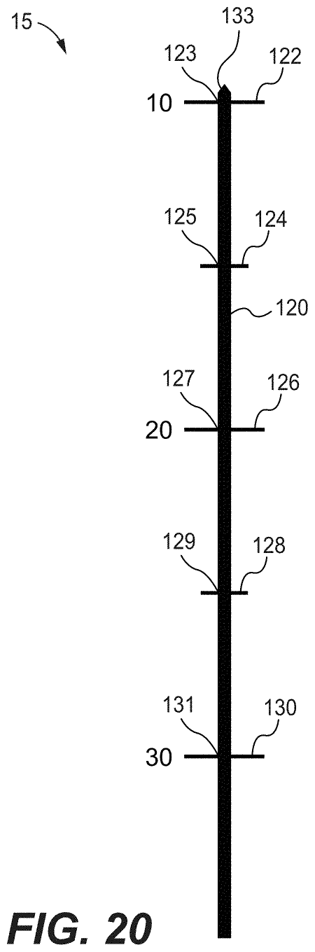

The fifth measurement mark 15 of the reticle 10 of FIG. 3 is provided in FIG. 20. In this embodiment, the fifth measurement mark 15 includes a vertical main bar 120 (or “vertical crosshair 120”) disposed along the vertical center line 500 of the reticle 10 and one or more horizontal lines or horizontal crosshairs disposed along the length of the main bar 120 intersecting the main bar 120. Suitably, each of the one or more horizontal crosshairs are graduated in angular measurement as graduated marks of incremental value in relation to the central aiming mark 11, in particular, in relation to a center point of the central aiming mark 11. In this embodiment, the fifth measurement mark 15 comprises a first horizontal crosshair 122 operationally configured as a graduated mark covering 10.0 MRAD from the center point of the central aiming mark 11 to a first intersection point 123 of the first horizontal crosshair 122 and the main bar 120. In this embodiment, the fifth measurement mark 15 also comprises (1) a second horizontal crosshair 124 operationally configured as a graduated mark covering 15.0 MRAD from the center point of the central aiming mark 11 to a second intersection point 125, (2) a third horizontal crosshair 126 operationally configured as a graduated mark covering 20.0 MRAD from the center point of the central aiming mark 11 to a third intersection point 127, (3) a fourth horizontal crosshair 128 operationally configured as a graduated mark covering 25.0 MRAD from the center point of the central aiming mark 11 to a fourth intersection point 129, and (4) a fifth horizontal crosshair 130 operationally configured as a graduated mark covering 30.0 MRAD from the center point of the central aiming mark 11 to a fifth intersection point 131. As shown, the widths of the horizontal crosshairs 122, 124, 126, 128 and 130 may vary for visual ease of use. In this embodiment, the horizontal crosshairs 122, 126 and 130 are wider than horizontal crosshairs 124, and 128. In another embodiment, the horizontal crosshairs 122, 124, 126, 128 and 130 may comprise a uniform width. In another embodiment, one or more horizontal hash marks may be used as graduated mark(s) along the main bar 120 in addition to or in place of horizontal crosshairs.

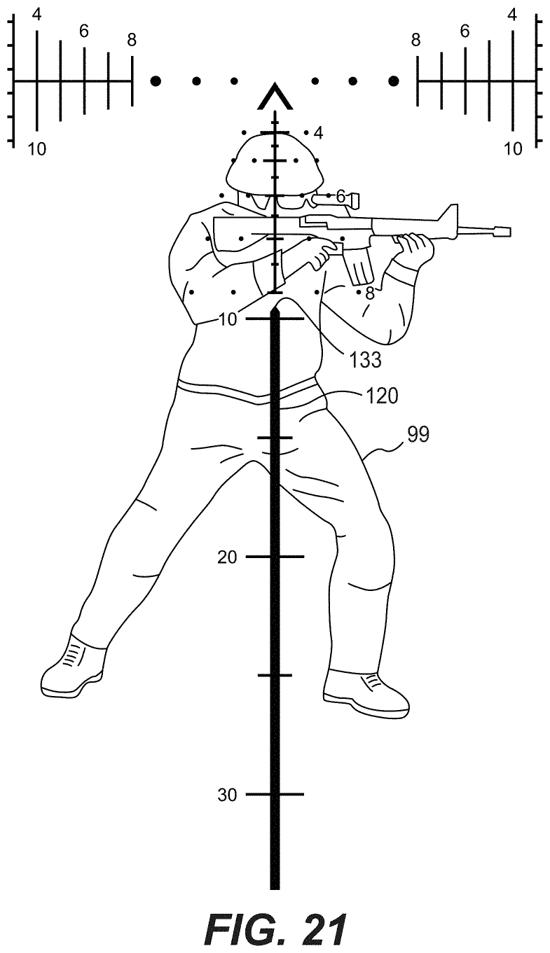

In this embodiment, an uppermost end 133 of the main bar 120, i.e., at the apex of the uppermost end 133, is operationally configured as a target aiming point, target aiming mark, exact firing aiming mark, or point of impact on an enemy combatant 99, or other target object(s), for one or more firearm shots fired at a close quarter combat distance of or about 6.0 meters or less from the reticle 10. In military and law enforcement type settings, at a distance of or about 6.0 meters or less a shooter may simply point and shoot at an enemy combatant 99 using the uppermost end 133 as an aiming point (see FIG. 21).

A reticle 10 of this disclosure may further comprise one or more additional close quarter combat target aiming points. For example, the fourth horizontal crosshair 35 may be operationally configured as a target aiming point, exact firing aiming mark, or point of impact on an enemy combatant 99 for one or more firearm shots fired at a close quarter combat distance of or about 10.0 meters from the reticle 10; the second horizontal crosshair 33 may be operationally configured as a target aiming point, exact firing aiming mark, or point of impact on an enemy combatant 99 for one or more firearm shots fired at a close quarter combat distance of or about 15.0 meters from the reticle 10; and the first horizontal crosshair 32 may be operationally configured as a target aiming point, exact firing aiming mark, or point of impact on an enemy combatant 99 for one or more firearm shots fired at a close quarter combat distance of or about 20.0 meters from the reticle 10.

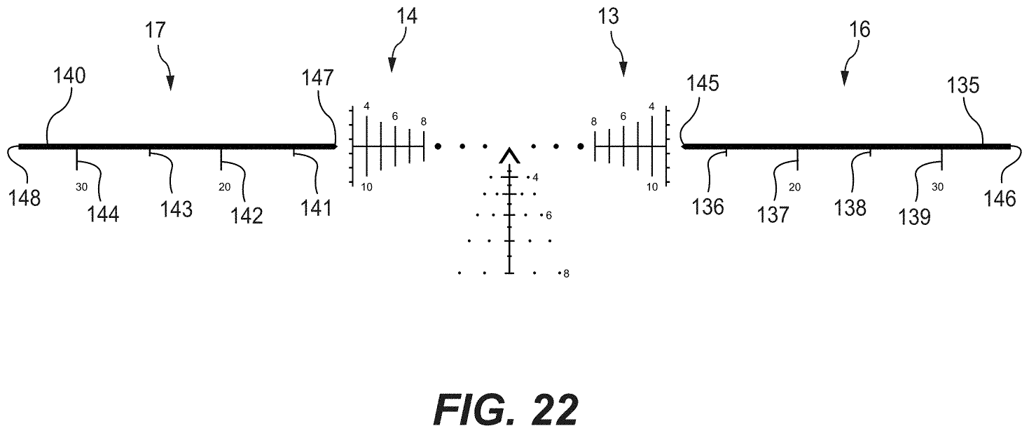

With reference to FIG. 22, the sixth measurement mark 16 and the seventh measurement mark 17 of the reticle 10 are mirror-image linear marks located adjacent the third measurement mark 13 and the fourth measurement mark 14 as shown. In this embodiment, the sixth measurement mark 16 includes a horizontal crosshair or “main bar 135” and one or more vertical hash marks graduated in angular measurement as graduated marks of incremental value in relation to the central aiming mark 11, in particular, in relation to a center point of the central aiming mark 11. In this embodiment, the sixth measurement mark 16 comprises a first vertical hash mark 136 operationally configured as a graduated mark covering 15.0 MRAD from the center point of the central aiming mark 11 to the junction point between the hash mark 136 and the main bar 135. In this embodiment, the sixth measurement mark 16 also comprises (1) a second vertical hash mark 137 operationally configured as a graduated mark covering 20.0 MRAD from the center point of the central aiming mark 11 to the junction point between the hash mark 137 and the main bar 135, (2) a third vertical hash mark 138 operationally configured as a graduated mark covering 25.0 MRAD from the center point of the central aiming mark 11 to the junction point between the hash mark 138 and the main bar 135, and (3) a fourth vertical hash mark 139 operationally configured as a graduated mark covering 30.0 MRAD from the center point of the central aiming mark 11 to the junction point between the hash mark 139 and the main bar 135. As shown, the seventh measurement mark 17 comprises a main bar 140 and vertical hash marks 141, 142, 143, 144 graduated in angular measurement as graduated marks of incremental value of 15.0 MRAD, 20.0 MRAD, 25.0 MRAD and 30.0 MRAD in relation to the central aiming mark 11, in particular, in relation to a center point of the central aiming mark 11 in like manner as the sixth measurement mark 16 described above. As further shown in FIG. 22, the main bar 135 may include a proximal end 145 and a distal end 146 and the main bar 140 may include a proximal end 147 and a distal end 148. In this embodiment, the proximal ends 145 and 147 are spaced apart from the third and fourth measurement marks 13 and 14 a distance effective to minimize obstruction of target objects when using hash marks 100, 101, 102, 103, 104, 105 and hash marks 106, 107, 108, 109, 110, 111. The location of the distal ends 146 and 148 is not limited to a particular angular measurement in relation to the central aiming mark 11, but may vary as described below. Herein, the sixth measurement mark 16 and the seventh measurement mark 17 may also be referred to as “second angular measurement side scales” of the reticle 10 in relation to the central aiming mark 11.

In one embodiment, the central aiming mark 11, lead mark 76, lead mark 77, the third measurement mark 13, the fourth measurement mark 14, the sixth measurement mark 16, and the seventh measurement mark 17 may be collectively referred to as a “horizontal angular measurement scale” of the reticle 10. In one embodiment, the central aiming mark 11, lead mark 76, the third measurement mark 13, and the sixth measurement mark 16 may be referred to as a “first horizontal angular measurement scale” and the central aiming mark 11, lead mark 77, the fourth measurement mark 14, and the seventh measurement mark 17 may be referred to as a “second horizontal angular measurement scale” of the reticle 10.

In another embodiment of the reticle 10, one or more hash marks 136, 137, 138, 139 and/or one or more hash marks 141, 142, 143, 144 may be provided as vertical crosshairs including an upper segment disposed above the main bars 135 and 140 and a lower segment disposed below the main bars 135 and 140. In another embodiment, a reticle 10 may include a linear measurement mark similar as the fifth measurement mark 15 or the sixth and seventh measurement marks 16 and 17 that is disposed radially above at a distance from and in line with the central aiming mark 11 as an “upper post” of the reticle 10. In another embodiment, one or more other indicia as described in this disclosure may be employed as angular measurement marks along one or more of the fifth, sixth and seventh measurement marks 15, 16 and 17.

Referring to FIG. 3, the fifth measurement mark 15 may comprise at least one angular measurement numeral corresponding to a particular horizontal crosshair indicating an angular distance from the intersection points of the horizontal crosshairs with the main bar 120 to a center point of the central aiming mark 11—see angular measurement numeral “10” adjacent first horizontal crosshair 122, angular measurement numeral “20” adjacent third horizontal crosshair 126 and angular measurement numeral “30” adjacent fifth horizontal crosshair 130. Also, the sixth and seventh measurement marks 16 and 17 may each comprise at least one angular measurement numeral corresponding to a particular vertical hash mark indicating an angular distance from the junction points of the vertical hash marks with the main bars 135 and 140 to a center point of the central aiming mark 11—see angular measurement numeral “20” adjacent hash marks 137 and 142 and angular measurement numeral “30” adjacent hash marks 139 and 144.

In addition to functioning as angular measurement marks, the hash marks of the fifth, sixth and seventh measurement marks 15, 16 and 17 are also operationally configured as guide marks for guiding a user of the reticle 10 to one or more targets in real time. Herein referred to as “target guidance,” “walk-in guidance,” and/or “walking in a shooter to a target” or like terms, in one embodiment a first person in possession of a first reticle 10 may assist a second person in possession of a second reticle 10 in detecting one or more particular target objects in real time by using the fifth, sixth and seventh measurement marks 15, 16 and 17 alone or with one or more other indicia of the reticle 10 as reference points according to an identified object viewable by both persons. For example, where two persons with firearms both of which are equipped with a reticle 10 as shown in FIG. 3 are actively attempting to locate a common enemy combatant 99, a first person may identify the enemy combatant 99 and then assist the second person in locating the enemy combatant 99 by first referencing a particular object visible to both persons (referred to herein as a “reference point”) and then use the various indicia of the reticle 10 to locate the enemy combatant 99 in relation to the reference point.

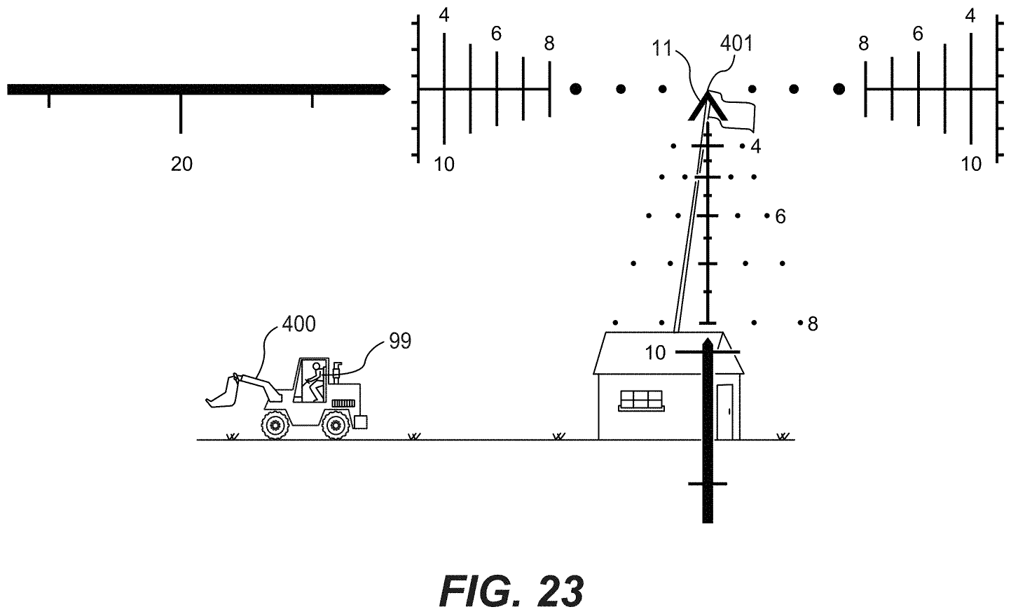

With reference to FIG. 23, in one simplified example of target guidance using the reticle 10 of FIG. 3, a first person may locate an enemy combatant 99 operating heavy equipment 400. If the second person cannot locate the enemy combatant 99 then the first person may identify a reference point such as the top of a flag pole 401 identifiable to the second person to provide the second person with a reference point for initial aiming of the central aiming mark 11. In particular, the first person may instruct the second person to aim the central aiming mark 11 at the top of the flag pole 401 as shown. The first person may then instruct the second person as to the location of the enemy combatant 99 using the indicia of the reticle 10, e.g., instructing the second person to look leftward along the seventh measurement mark 17 to about the 15.0 MRAD mark and then downward along the fifth measurement mark 15 to about the 12.0 MRAD point. Once the second person locates the enemy combatant 99, the second person may then relocate the reticle 10 as described above for horizontal and/or vertical ranging and/or aiming of the enemy combatant 99.

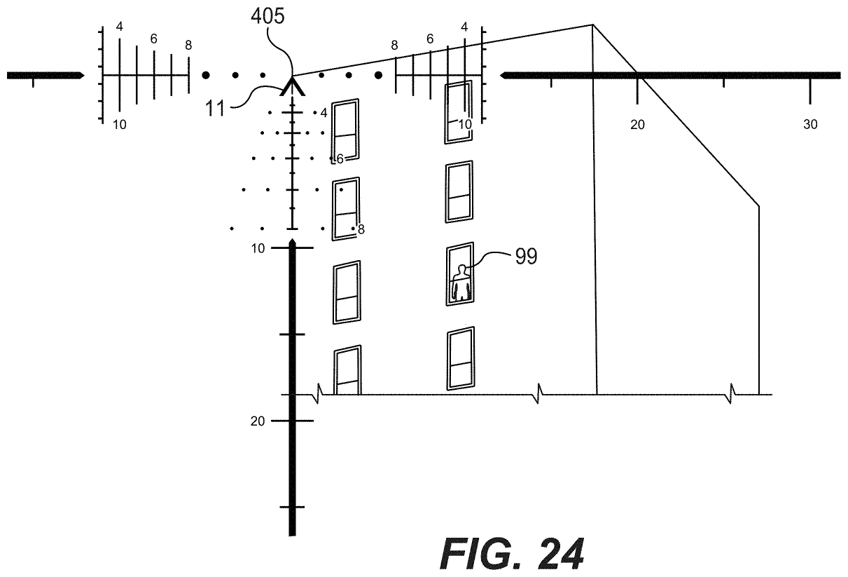

The fifth, sixth and seventh measurement marks 15, 16 and 17 may also be used as guide marks with the third and fourth measurement marks 13 and 14. For example, looking at FIG. 24, if a second person cannot locate an enemy combatant 99 then the first person whom has identified the location of the enemy combatant 99 may identify a reference point such as the top left corner of a building 405 identifiable to the second person to provide the second person with a reference point for initial aiming of the central aiming mark 11. In particular, the first person may instruct the second person to aim the central aiming mark 11 at the top left corner of the building 405 as shown. The first person may then instruct the second person as to the location of the enemy combatant 99 using the indicia of the reticle 10, e.g., instructing the second person to look downward along the fifth measurement mark 15 to about the 12.0 MRAD mark and then to the right to about the 10.0 MRAD mark of the third measurement mark 13.

Although the reticle 10 may be provided with a single side scale as shown in FIG. 18, another advantageous feature of a reticle 10 comprising the fifth, sixth and seventh measurement marks 15, 16 and 17 includes the whole breadth or width of the reticle 10 and the height of the reticle 10 realized by the inclusion of the fifth, sixth and seventh measurement marks 15, 16 and 17. Suitably, a reticle 10 of this disclosure provides increased height and width across the field of view of an optical sight and target area. With reference to FIG. 3, in one embodiment a reticle 10 of this disclosure may comprise a width of an angular distance of 30.0 MRAD or more. In another embodiment, a reticle 10 of this disclosure may comprise a width of an angular distance of 40.0 MRAD or more. In another embodiment, a reticle 10 of this disclosure may comprise a width of an angular distance of 50.0 MRAD or more. In another embodiment, a reticle 10 of this disclosure may comprise a width of an angular distance of 60.0 MRAD or more. In another embodiment, a reticle 10 of this disclosure may comprise a width of an angular distance of 70.0 MRAD or more. In another embodiment, a reticle 10 of this disclosure may comprise a width of an angular distance of 80.0 MRAD or more.

In one embodiment, a reticle 10 of this disclosure may comprise a height of an angular distance of or about 12.5 MRAD or more. In another embodiment, a reticle 10 of this disclosure may comprise a height of an angular distance of or about 17.5 MRAD or more. In another embodiment, a reticle 10 of this disclosure may comprise a height of an angular distance of or about 22.5 MRAD or more. In another embodiment, a reticle 10 of this disclosure may comprise a height of an angular distance of or about 27.5 MRAD or more. In another embodiment, a reticle 10 of this disclosure may comprise a height of an angular distance of or about 32.5 MRAD or more. In another embodiment, a reticle 10 of this disclosure may comprise a height of an angular distance of or about 37.5 MRAD or more. In another embodiment, a reticle 10 of this disclosure may comprise a height of an angular distance of or about 42.5 MRAD or more.

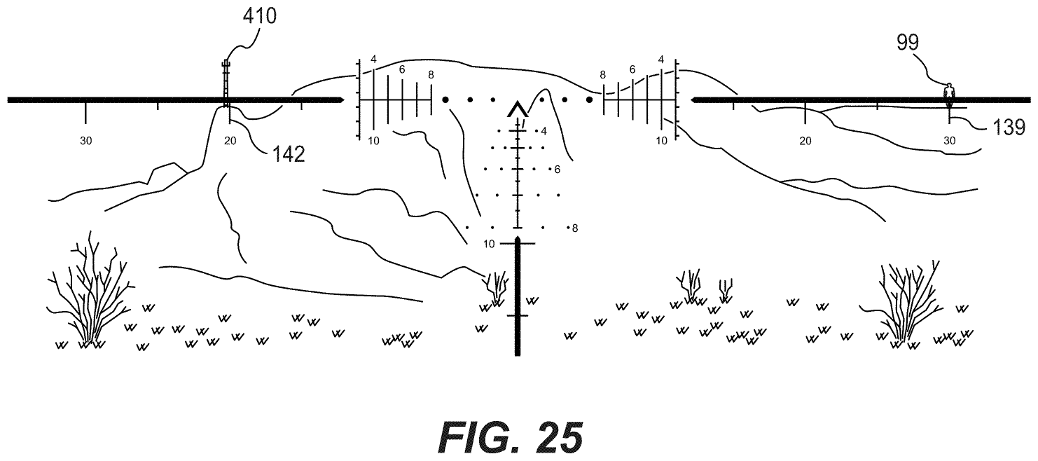

In the non-limiting examples of FIGS. 23 and 24, the location of the reference point in relation to the enemy combatant 99 illustrates use of the central aiming mark 11 with the fifth measurement mark 15 and one of the sixth or seventh measurement marks 16, 17 or one of the third or fourth measurement marks 13, 14. In another embodiment, the sixth and seventh measurement marks 16, 17 may be used for target guidance. For example, either the sixth measurement mark 16 or the seventh measurement marks 17 may be used to identify a reference point and the other measurement mark may be used to locate an enemy combatant 99 in relation thereto. With reference to FIG. 25, in a scenario where a second person cannot locate a particular enemy combatant 99 that has been located by a first person, the first person may identify a reference point such as a tall antenna 410 located far left of an enemy combatant 99 providing the second person with a reference point for locating the enemy combatant 99. For example, the first person may instruct the second person to locate the 20.0 MRAD mark (vertical hash mark 142) of the seventh measurement mark 17 at the antenna 410. Once the second person has aimed the 20.0 MRAD mark at the antenna 410, the first person may then instruct the second person as to the location of the enemy combatant 99 in relation to the indicia of the reticle 10 according to this aiming setting. For example, the first person may instruct the second person to look at the 30.0 MRAD mark (vertical hash mark 139) of the sixth measurement mark 16 to locate the enemy combatant 99. As understood by persons of ordinary skill in the art of optical sights, target guidance may also take into consideration the magnification of the optical sights in use at the time as the scale of the reticle 10 is determined according to the field of view.

Suitably, the horizontal lines, vertical lines, dots and/or other indicia of a reticle 10 of this disclosure may be provided in one or more colors as desired. For example, a reticle 10 may be provided in black color. In another exemplary embodiment, the central aiming mark 11 may be provided in a red color or red illumination. In another exemplary embodiment, the central aiming mark 11 may be provided in a green color or green illumination. In another exemplary embodiment, the central aiming mark 11 may be provided in orange color or orange illumination. In another exemplary embodiment, the central aiming mark 11 may be provided in a yellow color or yellow illumination. In still another embodiment, a reticle 10 of this disclosure may include indicia comprised of a plurality of colors and/or color illuminations.

The disclosure will be better understood with reference to the following non-limiting examples, which are illustrative only and not intended to limit the disclosure.

### EXAMPLE 1

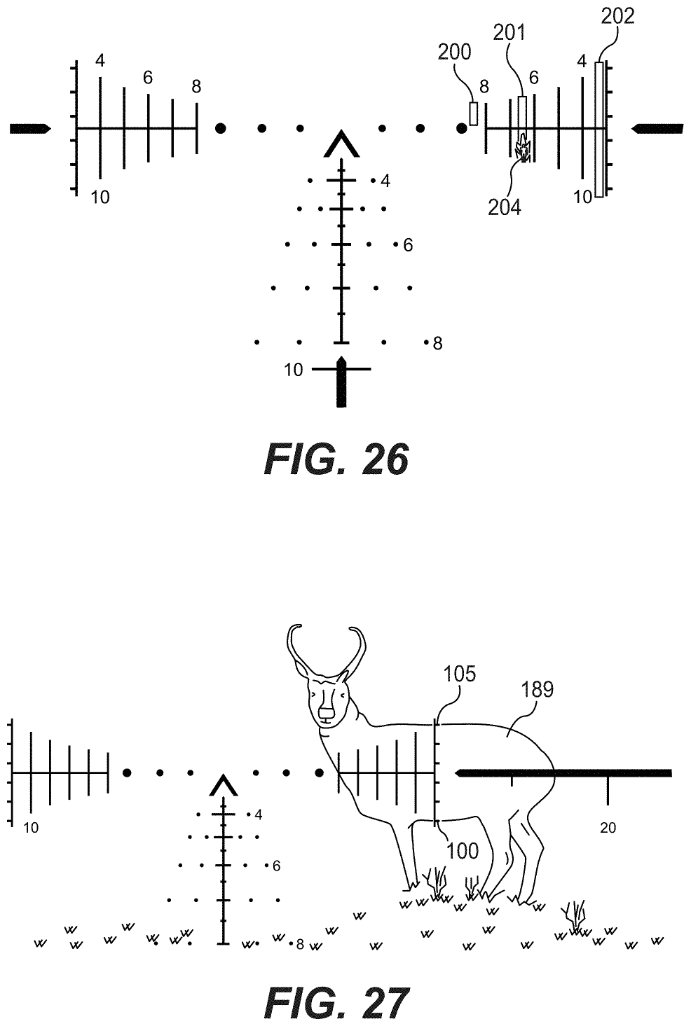

In a first non-limiting example, a weapon system including a 5.56 mm, magazine-fed, air cooled, semi-automatic rifle operationally configured for accurate non-optic use out to a distance of about 300.0 meters is provided. An optical sight comprising a reticle 10 as shown in FIG. 1 is provided for use with the weapon system whereby the reticle 10 is operationally configured to extend the accuracy of the rifle out to about 800.0 meters in relation to a target object having a height of 1.7 meters. FIG. 26 depicts vertical auto ranging of various target objects including (1) a target object 200 at a distance of 1600.0 meters from the reticle 10; (2) a partially exposed target object 201 at a distance of 600.0 meters from the reticle 10 (see bush 204 partially obstructing the target object 201); and (3) a target object 202 at a distance of 300.0 meters from the reticle 10.

### EXAMPLE 2

In a second non-limiting example, an optical sight comprising a reticle 10 as shown in FIG. 1 is provided for use with a Remington® Model 700 chambered for a 6.5 Creedmoor for purposes of hunting adult pronghorn 189 of an average size of 45.72 cm (18.0 inches) from belly to back. As shown in FIG. 27, the hash marks 100, 101, 102, 103, 104, 105 of the third measurement mark 13 may be used for horizontal range estimation of a pronghorn 189 using the formula of Table 5, which is reproduced below in Table 6.

TABLE 6
Known Size of Target Object (18.0 inches) × 25.4/MRAD
Size of Target Object = Distance (meters).

In this example, the pronghorn, from belly to back, covers a measured 5.0 MRAD from hash mark 100 to hash mark 105. Dividing 457.2 by 5.0 equals 91.44 meters, which means that the pronghorn 189 is a distance of or about 91.44 meters from the reticle 10.

To calculate the distance to the pronghorn in yards, the MIL Relation formula is used including a constant of 27.77 as shown in Table 7.

TABLE 7
Known Size of Target Object (18.0 inches) × 27.77/MRAD
Size of Target Object = Distance (yards).

In this example, the pronghorn, from belly to back, covers a measured 5.0 MRAD from hash mark 100 to hash mark 105. Dividing 499.86 by 5.0 equals 99.97 yards, which means that the pronghorn 189 is a distance of or about 99.97 yards from the reticle 10.

### Example 3

In a third non-limiting example including a reticle 10 as shown in FIG. 1, one or more formulas as described in Tables 8, 9 and 10 below may be employed to range estimate one or more target objects including, but not limited to an enemy combatant 99.

TABLE 8
Known Size of Target Object in Meters × 1000/MRAD
Size of Target Object = Distance (meters).

TABLE 9
Known Size of Target Object in Centimeters × 10/MRAD
Size of Target Object = Distance (meters).

TABLE 10
Known Size of Target Object in Yards × 1000/MRAD
Size of Target Object = Distance (yards).

### Example 4

In a fourth non-limiting example, a weapon system including a 5.56 mm, magazine-fed, air cooled, semi-automatic rifle operationally configured for accurate non-optic use out to a distance of about 300.0 meters is provided. A reticle 10 as illustrated in any of FIGS. 1, 18, 30 and 34 may be provided for use with the weapon system whereby the reticle 10 is operationally configured to extend the accuracy of the rifle out to about 800.0 meters. The width of the chevron type central aiming mark 11 at its base 19 is 1.61 MRAD (5.53 MOA) corresponding to a center mass of 0.48 meters (19.0 inches) at 300.0 meters. The height of the central aiming mark 11 is 1.19 MRAD (4.10 MOA). The distance between the outer tip 20 and the inner corner 21 of the central aiming mark 11 is 0.42 MRAD (1.46 MOA). The first central vertical crosshair 30, the primary horizontal crosshairs 32, 33, 34, 35, 36, the horizontal crosshairs 78, 85 and vertical crosshairs 79, 80, 81, 82, 83, 84 and 86, 87, 88, 89, 90, 91 each have a thickness of 0.116 MRAD (0.40 MOA).

### Example 5

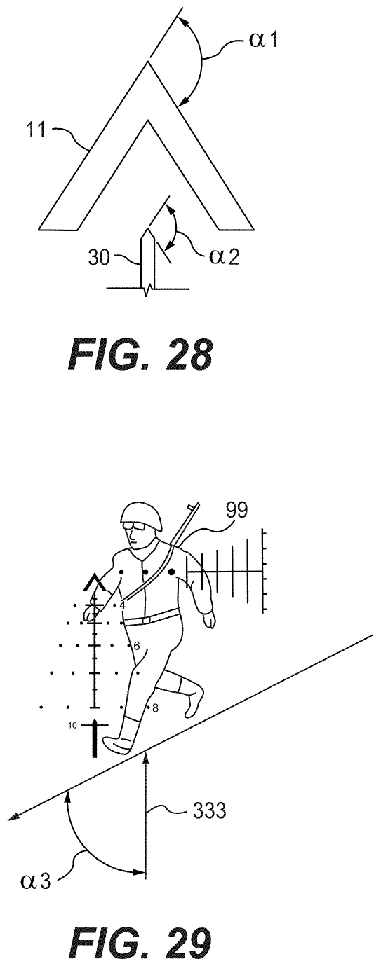

In an fifth non-limiting example, a reticle 10 as illustrated in any of FIGS. 1, 18, 30 and 34 may include a central aiming mark 11 and a first central vertical crosshair 30 with angles as listed below in reference to FIG. 28:
α1: 112.0 degrees;
α2: 112.0 degrees.

### Example 6

In a sixth non-limiting example, a reticle 10 as shown in FIG. 1 may comprise one or more additional wind adjustment dots and/or one or more additional horizontal crosshairs graduated in angular measurement disposed along the main bar 120 of the fifth measurement mark 15 and/or one or more additional vertical hash marks graduated in angular measurement disposed along the sixth measurement mark 16 and/or one or more additional vertical hash marks graduated in angular measurement disposed along the seventh measurement mark 17.

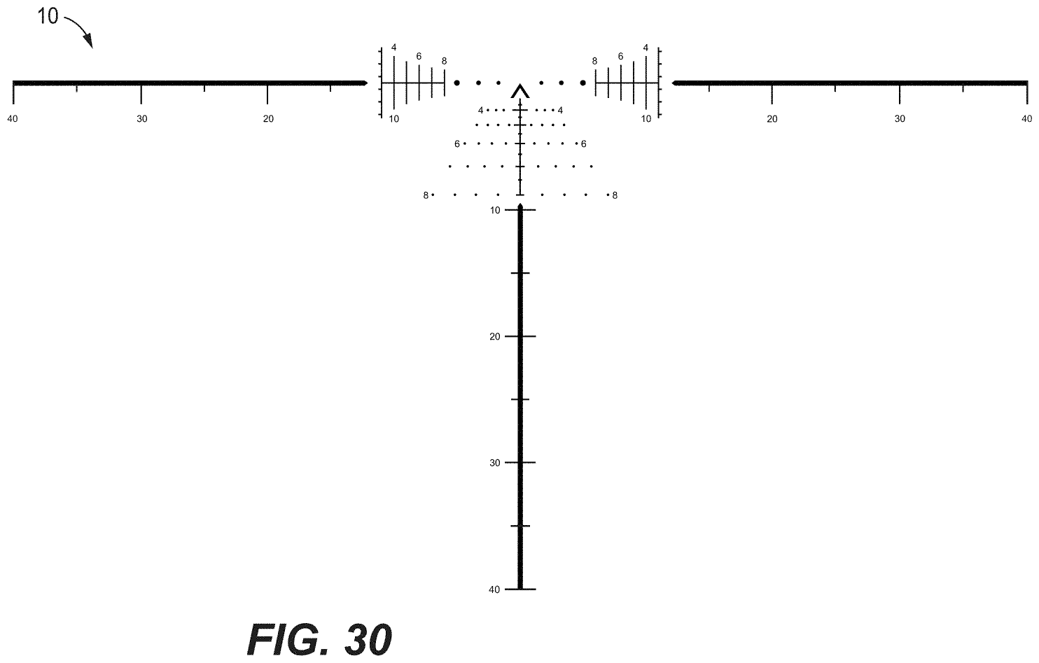

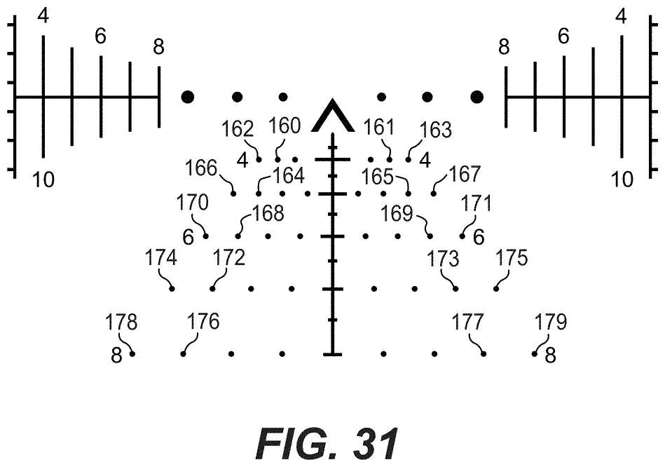

With reference to FIGS. 30-33, in an embodiment the reticle 10 may include one or more additional sets of wind adjustment dots on opposite sides of the crosshairs 32, 33, 34, 35, 36 at distances effective to provide uniform wind adjustment settings to compensate for an average cross wind velocity or speed of 6.7 mps (15.0 mph) and 8.9 mps (20.0 mph). For example, the reticle 10 may include a set of wind adjustment dots 160, 161 on opposite sides of the first horizontal crosshair 32 at a distance effective to compensate for an average cross wind speed of 6.7 mps (15.0 mph) and a set of wind adjustment dots 162, 163 at a distance effective to compensate for an average cross wind speed of 8.9 mps (20.0 mph). The reticle 10 may also include a set of wind adjustment dots 164, 165 on opposite sides of the second horizontal crosshair 33 at a distance effective to compensate for an average cross wind speed of 6.7 mps (15.0 mph) and a set of wind adjustment dots 166, 167 at a distance effective to compensate for an average cross wind speed of 8.9 mps (20.0 mph). The reticle 10 may also include a set of wind adjustment dots 168, 169 on opposite sides of the third horizontal crosshair 34 at a distance effective to compensate for an average cross wind speed of 6.7 mps (15.0 mph) and a set of wind adjustment dots 170, 171 at a distance effective to compensate for an average cross wind speed of 8.9 mps (20.0 mph). The reticle 10 may also include a set of wind adjustment dots 172, 173 on opposite sides of the fourth horizontal crosshair 35 at a distance effective to compensate for an average cross wind speed of 6.7 mps (15.0 mph) and a set of wind adjustment dots 174, 175 at a distance effective to compensate for an average cross wind speed of 8.9 mps (20.0 mph). The reticle 10 may also include a set of wind adjustment dots 176, 177 on opposite sides of the fifth horizontal crosshair 36 at a distance effective to compensate for an average cross wind speed of 6.7 mps (15.0 mph) and a set of wind adjustment dots 178, 179 at a distance effective to compensate for an average cross wind speed of 8.9 mps (20.0 mph).

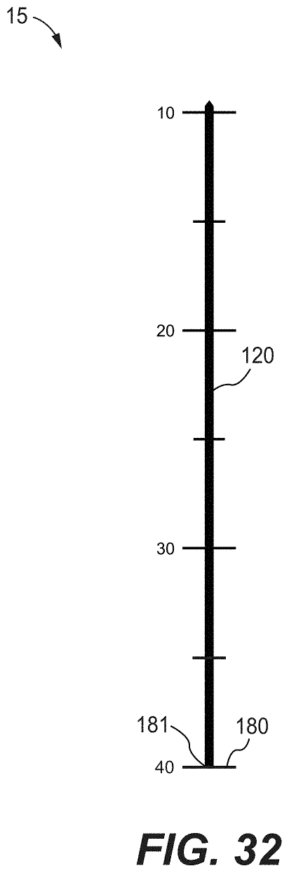

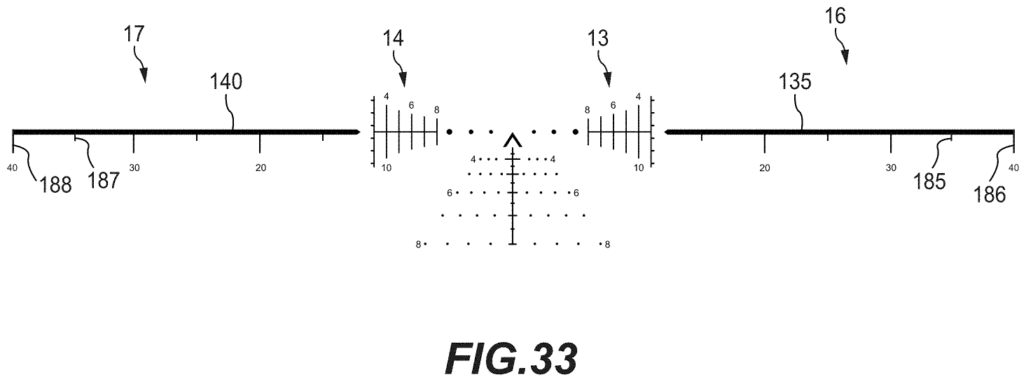

With reference to FIG. 32, the fifth measurement mark 15 may include a sixth horizontal crosshair 180 intersecting the main bar 120 operationally configured as a graduated mark covering 40.0 MRAD from the center point of the central aiming mark 11 to a sixth intersection point 181. With reference to FIG. 33, the main bar 135 of the sixth measurement mark 16 may include a fifth vertical hash mark 185 operationally configured as a graduated mark covering 35.0 MRAD from the center point of the central aiming mark 11 to a junction point of the hash mark 185 and the main bar 135 and include a sixth vertical hash mark 186 operationally configured as a graduated mark covering 40.0 MRAD from the center point of the central aiming mark 11 to a junction point of the hash mark 186 and the main bar 135. In like manner, the main bar 140 of the seventh measurement mark 17 may include a fifth vertical hash mark 187 operationally configured as a graduated mark covering 35.0 MRAD from the center point of the central aiming mark 11 to a junction point of the hash mark 187 and the main bar 140 and include a sixth vertical hash mark 188 operationally configured as a graduated mark covering 40.0 MRAD from the center point of the central aiming mark 11 to a junction point of the hash mark 188 and the main bar 140.

### Example 7

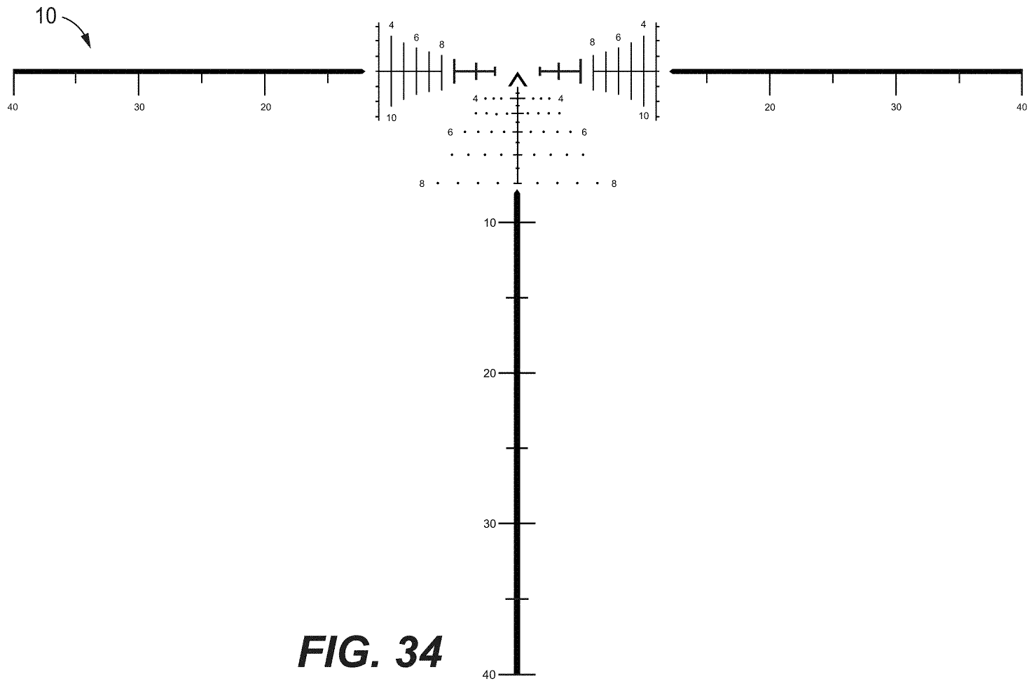

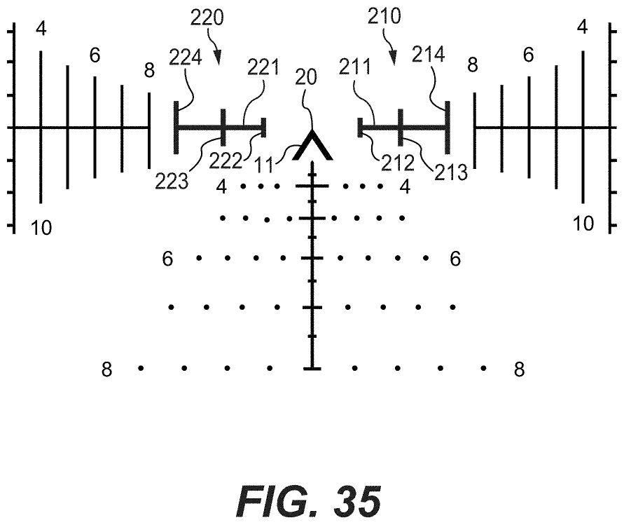

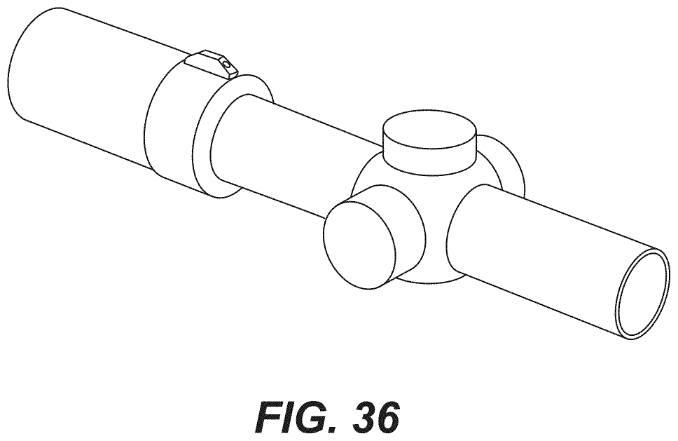

In a seventh non-limiting example a reticle 10 of this disclosure may include lead marks in a form other than the first set 70 and second set 71 comprising free standing moving target lead marks as described above. Referring to FIGS. 34 and 35, in an embodiment the eighth measurement mark may include a first target lead side scale 210 positioned right of the central aiming mark 11 and the ninth measurement mark may include a second target lead side scale 220 positioned left of the central aiming mark 11. As shown, side scale 210 and side scale 220 may be provided as mirror-image side scale indicia for aiming at a moving enemy combatant 99 traveling at one of three paces, namely, (1) walking, (2) jogging, and (3) running as described above. In this embodiment, side scale 210 comprises a horizontal line (or “horizontal crosshair 211”) aligned lengthwise with the uppermost part 20 of the central aiming mark 11 and disposed along the horizontal center line 501 of the reticle 10. Side scale 210 also comprises vertical crosshairs 212, 213, 214 (or “lead marks 212, 213, 214”) of varying length intersecting the horizontal crosshair 211 at a midpoint of each of the vertical crosshairs 212, 213, 214 at a different point along the length of the horizontal crosshair 211. In this embodiment, the vertical crosshair 212 is operationally configured as a walking lead mark whereby the location of the vertical crosshair 212 in relation to the uppermost part 20 of the central aiming mark 11 correlates to an enemy combatant 99 walking at 4.99 km/h (3.1 mph). The vertical crosshair 213 is operationally configured as a jogging lead mark whereby the location of the vertical crosshair 213 in relation to the uppermost part 20 of the central aiming mark 11 correlates to an enemy combatant 99 jogging at 9.82 km/h (6.1 mph). The vertical crosshair 214 is operationally configured as a running lead mark whereby the location of the vertical crosshair 214 in relation to the uppermost part 20 of the central aiming mark 11 correlates to an enemy combatant 99 running at 13.8 km/h (8.6 mph).

As stated above, the second target lead side scale 220 mirrors the first target lead side scale 210 and comprises a horizontal line (or “horizontal crosshair 221”) disposed along a center horizontal line of the reticle 10 and vertical crosshairs 222, 223, 224 (or “lead marks 222, 223, 224”) as depicted in FIG. 35 wherein the location of the vertical crosshair 222 in relation to the uppermost part 20 of the central aiming mark 11 correlates to an enemy combatant 99 walking at 4.99 km/h (3.1 mph); the location of the vertical crosshair 223 in relation to the uppermost part 20 of the central aiming mark 11 correlates to an enemy combatant 99 jogging at 9.82 km/h (6.1 mph); and the location of the vertical crosshair 224 in relation to the uppermost part 20 of the central aiming mark 11 correlates to an enemy combatant 99 running at 13.8 km/h (8.6 mph).

Similar as described above, in an embodiment lead marks 212, 213, 214 and lead marks 222, 223, 224 may be located apart from the central aiming mark 11 at distances corresponding to walking, jogging and running travel speeds of an enemy combatant 99 that are rounded to the nearest whole number for the travel speeds.

The reticle 10 as shown in FIGS. 1, 18, 30 and 34 may be described according to one or more of the following Embodiments.

Embodiment 1. A reticle for an optical sight, comprising:
a first central scale;
one or more first side scales; and
one or more moving target lead marks;
wherein the first central scale includes:
a first measurement mark operationally configured as a primary horizontal auto ranging mark for a first target object at a base distance; and
a second measurement mark comprising one or more secondary horizontal auto ranging marks for the first target object at one or more incremental distances greater than the base distance;
wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and
wherein the one or more moving target lead marks are operationally configured as 90.0 degree target full value lead marks and wherein one or more of the one or more moving target lead marks are operationally configured as 45.0 degree target half value lead marks.

Embodiment 2. The reticle of Embodiment 1, wherein the one or more indicia of the one or more first side scales include a first horizontal mark, a plurality of vertical marks intersecting the first horizontal mark and a plurality of second horizontal marks, wherein the plurality of vertical marks are operationally configured as the vertical auto ranging marks and the horizontal angular measurement marks and wherein the plurality of second horizontal marks are operationally configured as the vertical angular measurement marks.

Embodiment 3. The reticle of Embodiment 1, wherein the one or more indicia of the one or more first side scales include a first horizontal mark, a plurality of vertical marks intersecting the first horizontal mark and a plurality of second horizontal marks, wherein the first horizontal mark and the plurality of vertical marks are operationally configured as vertical auto ranging marks according to a selected full height and a selected half height of the first target object at the base distance and the one or more incremental distances and wherein the plurality of second horizontal marks are operationally configured as the vertical angular measurement marks of the one or more second target objects.

Embodiment 4. The reticle of Embodiment 2, wherein the plurality of second horizontal marks extend out from a vertical mark of the plurality of vertical marks in angular measurement incremental distances.

Embodiment 5. The reticle of Embodiment 2, wherein the plurality of second horizontal marks extend out from a vertical mark of the plurality of vertical marks that is operationally configured to vertically auto range the first target object at the base distance.

Embodiment 6. The reticle of Embodiment 3, wherein the plurality of second horizontal marks extend out from a vertical mark of the plurality of vertical marks that is operationally configured to vertically auto range the first target object at the base distance.

Embodiment 7. The reticle of Embodiment 2, wherein the first horizontal mark and the plurality of vertical marks are operationally configured as the vertical auto range estimation marks according to a selected full height of the first target object and a selected half height of the first target object at one or more predetermined distances.

Embodiment 8. The reticle of Embodiment 1, wherein the one or more moving target lead marks are located between the first measurement mark and the one or more first side scales.

Embodiment 9. The reticle of Embodiment 8, wherein one or more of the one or more moving target lead marks are graduated marks of an angular distance from a center point of the first measurement mark.

Embodiment 10. The reticle of Embodiment 1, wherein the first central scale includes wind adjustment marks corresponding to each of the one or more secondary horizontal auto ranging marks.

Embodiment 11. The reticle of Embodiment 1, wherein the one or more moving target lead marks include walking target lead marks, jogging target lead marks, and running target lead marks for the first target object traveling 90.0 degrees full value to an aiming line of sight emanating from the one or more moving target lead marks, and wherein the one or more moving target lead marks include jogging target lead marks and running target lead marks for the first target object traveling at 45.0 degrees half value to the aiming line of sight.

Embodiment 12. The reticle of Embodiment 1, further comprising a second central scale located below the first central scale wherein the second central scale is operationally configured for aiming of the first target object at one or more distances less than the base distance.

Embodiment 13. The reticle of Embodiment 1, further comprising one or more second side scales, wherein the one or more first side scales include a maximum angular distance from the first measurement mark and the one or more second side scales include a minimum angular distance from the first measurement mark greater than the maximum angular distance of the one or more first side scales.

Embodiment 14. The reticle of Embodiment 2, wherein the plurality of vertical marks are horizontal angular measurements marks graduated in angular measurement of 1.0 MRAD increments.

Embodiment 15. The reticle of Embodiment 4, wherein the plurality of second horizontal marks are set apart in 1.0 MRAD increments.

Embodiment 16. The reticle of Embodiment 1, wherein the reticle includes a width of an angular measurement up to 80.0 MRAD.

Embodiment 17. A reticle for an optical sight, comprising:
a first central scale;
a second central scale;
one or more first side scales; and
one or more moving target lead marks;
wherein the first central scale includes:
a first measurement mark operationally configured as a primary horizontal auto ranging mark for a first target object at a base distance; and
a second measurement mark comprising one or more secondary horizontal auto ranging marks for the first target object at one or more incremental distances greater than the base distance;
wherein the second central scale includes a vertical crosshair and one or more horizontal crosshairs graduated in angular measurement as graduated marks of incremental value in relation to the first measurement mark;
wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and
wherein the one or more moving target lead marks are operationally configured to lead the first target object when the first target object is traveling at a plurality of speeds 90.0 degree full value to an aiming line of sight emanating from the one or more moving target lead marks and wherein one or more of the one or more moving target lead marks are operationally configured to lead the first target object when the first target object is traveling at one or more of the plurality of speeds 45.0 degree half value to the aiming line of sight.

Embodiment 18. The reticle of Embodiment 17, further comprising one or more second side scales, wherein the one or more first side scales include a maximum angular distance from the first measurement mark and the one or more second side scales include a minimum angular distance from the first measurement mark greater than the maximum angular distance of the one or more first side scales.

Embodiment 19. A reticle for an optical sight, comprising:
a first central scale;
a second central scale located below the first central scale;
one or more first angular measurement side scales; and
one or more moving target lead marks;
wherein the first central scale is operationally configured for horizontal auto ranging of a first target object according to a selected center mass of the first target object at one or more predetermined first distances and operationally configured for aiming at the first target object at the one or more predetermined first distances and aiming at the first target object at one or more predetermined second distances;
wherein the second central scale is operationally configured for aiming of the first target object at one or more third distances less than the one or more predetermined first distances and the one or more predetermined second distances;
wherein the one or more first angular measurement side scales include indicia operationally configured as (1) vertical auto range estimation marks for the first target object according to a selected full height and selected half height of the first target object at the one or more predetermined first distances, (2) horizontal angular measurement marks for one or more second target objects of known dimensions, and (3) vertical angular measurement marks for the one or more second target objects; and
wherein the one or more moving target lead marks are operationally configured as 90.0 degree target full value lead marks and wherein one or more of the one or more moving target lead marks are operationally configured as 45.0 degree target half value lead marks.

Embodiment 20. The reticle of Embodiment 19, further comprising one or more second angular measurement side scales comprising a horizontal crosshair and one or more vertical hash marks graduated in angular measurement.

Embodiment 21. A method, comprising:

realizing an aiming point of a firearm optical sight reticle on a target object of known dimensions, the reticle including:
one or more aiming marks including a point of origin mark;
one or more auto ranging marks; and
one or more moving target lead marks;
wherein one or more of the one or more auto ranging marks and one or more of the one or more moving target lead marks are graduated in angular measurement in relation to the point of origin mark; and
wherein one or more of the one or more auto ranging marks are operationally configured as horizontal angular measurement marks and vertical angular measurement marks.

Embodiment 22. The method of Embodiment 21, wherein the one or more auto ranging marks graduated in angular measurement are vertical auto ranging marks.

Embodiment 23. The method of Embodiment 21, wherein the point of origin mark is a central aiming mark of the reticle and a horizontal auto ranging mark operationally configured to auto range the target object at a base distance.

Embodiment 24. The method of Embodiment 21, wherein the point of origin mark is a horizontal auto ranging mark.

Embodiment 25. The method of Embodiment 21, wherein the one or more auto range estimation marks include one or more horizontal auto ranging bullet drop compensation marks.

Embodiment 26. The method of Embodiment 21, wherein the one or more auto ranging marks and the one or more moving target lead marks graduated in angular measurement are operationally configured as horizontal angular measurement marks in relation to a center point of the central aiming mark for horizontal range estimation of the target object.

Embodiment 27. The method of Embodiment 21, wherein the one or more auto ranging marks and the one or more moving target lead marks graduated in angular measurement are graduated in angular measurement increments of 1.0 MRAD.

Embodiment 28. The reticle of Embodiment 1, wherein the base distance is 300.0 meters based on a center mass of the first target object of 19.0 inches.

Embodiment 29. The reticle of Embodiment 17, wherein the base distance is 300.0 meters based on a center mass of the first target object of 19.0 inches.

Embodiment 30. The reticle of Embodiment 19, wherein the one or more predetermined first distances include a base distance of 300.0 meters based on a center mass of the first target object of 19.0 inches.

Embodiment 31. A reticle, comprising:
a central scale;
one or more moving target leads for targets traveling at right angles and one or more oblique angles to an aiming line of sight of a user of the reticle; and
one or more side scales comprising one or more vertical auto range estimation marks in angular measurement increments.

Embodiment 32. A reticle, comprising:
a central scale;
one or more moving target leads for targets traveling at right angles and at one or more oblique angles to an aiming line of sight of a user of the reticle; and
one or more side scales comprising one or more vertical auto range estimation marks in 1.0 MRAD increments.

Embodiment 33. An optical sight reticle, comprising:
a central scale;
one or more moving target lead marks;
one or more side scales comprising one or more auto ranging/precision angular measurement integration marks;
wherein the one or more moving target lead marks are operationally configured to lead targets moving at multiple angles.

Embodiment 34. A reticle for an optical sight of a projectile launching device, comprising:
a first central scale comprising a center point mark;
a second central scale comprising one or more angular measurement marks;
one or more moving target lead marks; and
at least one horizontal angular measurement scale comprising the center point mark, at least one of the one or more moving target lead marks, an inner side scale and an outer side scale;
wherein the inner side scale comprises one or more auto ranging/precision angular measurement integration marks;
wherein the inner side scale comprises indicia operationally configured as vertical angular measurement marks; and
wherein the one or more moving target lead marks are operationally configured to lead targets moving at multiple angles.

Embodiment 35. The reticle of Embodiment 1, wherein at least one of the one or more secondary horizontal auto ranging marks is a wind adjustment mark.

Although the disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Terms and phrases used in this disclosure, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” “one or a plurality” or the like.

Persons of ordinary skill in the art will recognize that many modifications may be made to the disclosure without departing from the spirit and scope of the disclosure. The embodiment(s) described herein are meant to be illustrative only and should not be taken as limiting the invention, which is defined in the claims.

I claim:

1. A reticle for an optical sight, comprising:
a first central scale;
one or more first side scales; and
one or more moving target lead marks;
wherein the first central scale includes:
a first measurement mark operationally configured as a primary horizontal auto ranging mark for a first target object at a base distance; and
a second measurement mark comprising one or more secondary horizontal auto ranging marks for the first target object at one or more incremental distances greater than the base distance;
wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and
wherein the one or more moving target lead marks are operationally configured as 90.0 degree target full value lead marks and wherein one or more of the one or more moving target lead marks are operationally configured as 45.0 degree target half value lead marks.

2. The reticle of claim 1, wherein the one or more indicia of the one or more first side scales include a first horizontal mark, a plurality of vertical marks intersecting the first horizontal mark and a plurality of second horizontal marks, wherein the plurality of vertical marks are operationally configured as the vertical auto ranging marks and the horizontal angular measurement marks and wherein the plurality of second horizontal marks are operationally configured as the vertical angular measurement marks.

3. The reticle of claim 1, wherein the one or more indicia of the one or more first side scales include a first horizontal mark, a plurality of vertical marks intersecting the first horizontal mark and a plurality of second horizontal marks, wherein the first horizontal mark and the plurality of vertical marks are operationally configured as vertical auto ranging marks according to a selected full height and a selected half height of the first target object at the base distance and the one or more incremental distances and wherein the plurality of second horizontal marks are operationally configured as the vertical angular measurement marks of the one or more second target objects.

4. The reticle of claim 2, wherein the plurality of second horizontal marks extend out from a vertical mark of the plurality of vertical marks in angular measurement incremental distances.

5. The reticle of claim 2, wherein the plurality of second horizontal marks extend out from a vertical mark of the plurality of vertical marks that is operationally configured to vertically auto range the first target object at the base distance.

6. The reticle of claim 3, wherein the plurality of second horizontal marks extend out from a vertical mark of the plurality of vertical marks that is operationally configured to vertically auto range the first target object at the base distance.

7. The reticle of claim 2, wherein the first horizontal mark and the plurality of vertical marks are operationally configured as the vertical auto range estimation marks according to a selected full height of the first target object and a selected half height of the first target object at one or more predetermined distances.

8. The reticle of claim 1, wherein the one or more moving target lead marks are located between the first measurement mark and the one or more first side scales.

9. The reticle of claim 8, wherein one or more of the one or more moving target lead marks are graduated marks of an angular distance from a center point of the first measurement mark.

10. The reticle of claim 1, wherein the first central scale includes wind adjustment marks corresponding to each of the one or more secondary horizontal auto ranging marks.

11. The reticle of claim 1, wherein the one or more moving target lead marks include walking target lead marks, jogging target lead marks, and running target lead marks for the first target object traveling 90.0 degrees full value to an aiming line of sight emanating from the one or more moving target lead marks, and wherein the one or more moving target lead marks include jogging target lead marks and running target lead marks for the first target object traveling at 45.0 degrees half value to the aiming line of sight.

12. The reticle of claim 1, further comprising a second central scale located below the first central scale wherein the second central scale is operationally configured for aiming of the first target object at one or more distances less than the base distance.

13. The reticle of claim 1, further comprising one or more second side scales, wherein the one or more first side scales include a maximum angular distance from the first measurement mark and the one or more second side scales include a minimum angular distance from the first measurement mark greater than the maximum angular distance of the one or more first side scales.

14. The reticle of claim 2, wherein the plurality of vertical marks are horizontal angular measurements marks graduated in angular measurement of 1.0 MRAD increments.

15. The reticle of claim 4, wherein the plurality of second horizontal marks are set apart in 1.0 MRAD increments.

16. The reticle of claim 1, wherein the reticle includes a width of an angular measurement up to 80.0 MRAD.

17. A reticle for an optical sight, comprising:
a first central scale;
a second central scale;
one or more first side scales; and
one or more moving target lead marks;
wherein the first central scale includes:
a first measurement mark operationally configured as a primary horizontal auto ranging mark for a first target object at a base distance; and
a second measurement mark comprising one or more secondary horizontal auto ranging marks for the first target object at one or more incremental distances greater than the base distance;
wherein the second central scale includes a vertical crosshair and one or more horizontal crosshairs graduated in angular measurement as graduated marks of incremental value in relation to the first measurement mark;
wherein the one or more first side scales include one or more indicia operationally configured as vertical auto ranging marks for the first target object at the base distance and the one or more incremental distances, and operationally configured as horizontal angular measurement marks and vertical angular measurement marks for one or more second target objects; and
wherein the one or more moving target lead marks are operationally configured to lead the first target object when the first target object is traveling at a plurality of speeds 90.0 degree full value to an aiming line of sight emanating from the one or more moving target lead marks and wherein one or more of the one or more moving target lead marks are operationally configured to lead the first target object when the first target object is traveling at one or more of the plurality of speeds 45.0 degree half value to the aiming line of sight.

18. The reticle of claim 17, further comprising one or more second side scales, wherein the one or more first side scales include a maximum angular distance from the first measurement mark and the one or more second side scales include a minimum angular distance from the first measurement mark greater than the maximum angular distance of the one or more first side scales.

19. A reticle for an optical sight, comprising:
a first central scale;
a second central scale located below the first central scale;
one or more first angular measurement side scales; and
one or more moving target lead marks;
wherein the first central scale is operationally configured for horizontal auto ranging of a first target object according to a selected center mass of the first target object at one or more predetermined first distances and operationally configured for aiming at the first target object at the one or more predetermined first distances and aiming at the first target object at one or more predetermined second distances;
wherein the second central scale is operationally configured for aiming of the first target object at one or more third distances less than the one or more predetermined first distances and the one or more predetermined second distances;
wherein the one or more first angular measurement side scales include indicia operationally configured as (1) vertical auto range estimation marks for the first target object according to a selected full height and selected half height of the first target object at the one or more predetermined first distances, (2) horizontal angular measurement marks for one or more second target objects of known dimensions, and (3) vertical angular measurement marks for the one or more second target objects; and
wherein the one or more moving target lead marks are operationally configured as 90.0 degree target full value lead marks and wherein one or more of the one or more moving target lead marks are operationally configured as 45.0 degree target half value lead marks.

20. The reticle of claim 19, further comprising one or more second angular measurement side scales comprising a horizontal crosshair and one or more vertical hash marks graduated in angular measurement.
